(19) United States
(12) Patent Application Publication
(10) Pub. No.: US 2026/0067524 A1
(43) Pub. Date: Mar. 5, 2026

(54) ENHANCING SECONDARY CONTENT DURING CONSUMPTION OF PRIMARY CONTENT INCLUDING DYNAMIC CONTENT FOR SOCIAL MEDIA FEEDS IN INFINITE SCROLL FORMAT

(71) Applicant: Adeia Guides Inc., San Jose, CA (US)

(72) Inventors: Serhad Doken, Bryn Mawr, PA (US); Tao Chen, Palo Alto, CA (US); Aldis Sipolins, Somerville, MA (US); Jean-Yves Couleaud, Mission Viejo, CA (US)

(21) Appl. No.: 18/821,347

(22) Filed: Aug. 30, 2024

(51) Int. Cl. H04N 21/431; G06F 3/0485; H04N 21/466

(52) U.S. Cl. CPC H04N 21/4316; G06F 3/0485; H04N 21/4667

(57) ABSTRACT

Supplemental content in a content feed is adjusted based on various scrolling characteristics and screen buffer properties. A number of impressions of the supplemental content is increased. A duration of consumption of the supplemental content is extended. Characteristics like scrolling speed, acceleration, and direction of primary and secondary content are determined. A viewing time of the supplemental content is considered. In some embodiments, if vertical or horizontal screen space around the supplemental content falls below a threshold, the content is modified. Other adjustments relate to rotation of a viewing device, real world weather conditions, virtual reality presentation of the supplemental content, and the like. Related systems, apparatuses, devices, techniques, and articles are also described.

### FIELD OF THE DISCLOSURE

The present disclosure relates to scrollable interface applications (such as in social media, news feeds, or content browsing applications), advertising (including digital advertisement), user interfaces (UI) (including UI controls), content delivery, content processing, content rendering, and technologies for enhancing secondary (or supplemental) media during consumption of primary media.

### SUMMARY

The landscape of digital content provision and user interaction is in a state of continuous evolution. For marketers and advertisers, the challenge of ensuring effective engagement with advertisements (also referred to as one or more “ads” herein) remains significant. The digital content environment is often oversaturated with a multitude of content pieces competing for the attention of social media users and other digital consumers. Content creators and advertisers frequently promote their content for consumption by these users. In an approach, a content sharing application quantifies the number of user devices that have displayed a piece of content on the device screen for a brief duration. These quantifications, termed as impressions, serve as performance metrics for the content sharing application, indicating the level of attention a piece of content garners. Additional metrics may encompass interaction data such as the number of clicks received by the user device on the displayed content, the sharing of the content by a user profile on the content sharing application, and the liking of the content by the user profile, among other actions that enable a user on the user device to interact with the digital content.

In another approach, promoted content is programmed to be displayed in an “infinite” scroll format to enhance the content's performance metrics. Infinite scroll is a user interface design technique that continuously loads content as users scroll down a page. This technique facilitates uninterrupted and continuous content discovery for users on a content sharing application, thereby maintaining user engagement in consuming large volumes of content. Content creators and advertisers have leveraged content sharing applications that implement infinite scroll interfaces to garner more impressions from users on the content sharing application, given that users on infinite scroll interfaces cycle through extensive collections of content in a single session. Content creators and advertisers also promote their content on content sharing applications with infinite scroll due to the typically longer average user session on a content sharing application with infinite scroll compared to a content sharing application without infinite scroll. In one instance, a piece of promoted content may be displayed as a post alongside other non-promoted content in an infinite scroll interface.

However, in such an approach where promoted content is displayed alongside other posts in an infinite scroll, the average view time that the promoted content receives from a user synchronizes with the average view time of other posts, particularly when the promoted content does not specifically stand out when displayed to the user via a user device. Moreover, infinite scroll interfaces have become increasingly saturated with promoted content from content creators and advertisers competing for user impressions. It has become challenging for promoted content to capture value if impressions are evenly distributed among all posts in an infinite scroll.

In another approach, the promoted content may be a video posted in an infinite scroll interface to capture a longer session of user impressions, given that a user may be captivated by the movement in a video. However, a user can simply continue scrolling before the video ends. The user of the device may find the subsequent post in the infinite scroll more captivating, may not be paying attention to the content on the platform, may be distracted, may be thinking about something else, and/or may be mindlessly scrolling. This undermines the purpose of having promoted video content since the user, via the device, does not view, interact with, or engage with the video.

In yet another approach, a user might find a promoted video content engaging, but the length of the video could be too extensive for the user, via the device, to watch in full. Even though the user, via the device, may proceed to scroll through the content sharing application, the promoted video content misses potential impression metrics due to the user discontinuing their viewing of the video via the device.

To help address the limitations and problems of these and other approaches, methods and systems provide extra exposure to supplemental content (e.g., media promotions, ads, or the like) during consumption of primary content (e.g., social media content). For example, the primary and secondary (or supplemental) content are delivered by a content delivery platform (e.g., a social networking platform), and a potential duration and/or format of video playback is optimized for supplemental content (e.g., ads) that feature videos in a social media feed, even as a user continues to scroll through the social media feed.

In the various embodiments and examples delineated herein, various features are disclosed, each contributing to the enhancement of user interaction with secondary content, such as an advertisement, on a display screen.

For example, the secondary content undergoes modification contingent on the residual space between the secondary content (e.g., ad) and the periphery of the display screen during a scrolling operation. This feature ensures optimal utilization of the available screen real estate, thereby enhancing the visibility and impact of the ad.

Also, for example, a segment of secondary content (e.g., the ad) or its altered version is preserved, remaining “sticky” on the screen, even when a standard scrolling operation would typically have moved it beyond the edge of the display screen. This feature ensures persistent visibility of the secondary content (e.g., ad), thereby increasing the likelihood of user engagement.

Further, for example, an animated character is introduced, the visual attributes of which fluctuate as the secondary content (e.g., ad) nears the edge of the display screen during a scrolling operation. This feature is further extended to include changes in the character's appearance when the device is physically rotated between portrait and landscape orientations. The animated character serves as an engaging visual cue, drawing the user's attention to the secondary content (e.g., ad) via the device.

Still further, for example, enhanced messages are generated based on the scrolling behavior of the device. These messages can provide additional context or incentives to engage with the secondary content (e.g., ad), thereby enhancing user interaction.

In some embodiments, a system may access primary content being displayed in a content feed. The system may determine a scrolling characteristic (e.g., scrolling speed) of the primary content being displayed. The system may adjust supplemental content based on the scrolling characteristic of the content being displayed.

A method is provided for dynamic adjustment of supplemental content in a content feed based on scrolling characteristics of primary content being displayed. The method includes at least one of content adjustment, screen buffer consideration, feed buffer consideration, secondary content (e.g., ad) adjustment, video content control, dynamic image rendering, scrolling characteristics consideration, dynamic animation, external factor consideration, an infinite scroll environment, content creation, combinations of the same, or the like.

For example, a method accesses primary content and determines its scrolling characteristics. Based on these characteristics, it adjusts the supplemental content in the content feed. This solves the problem of static content presentation, enhancing user engagement by increasing interaction.

Also, for example, a method utilizes a size of a screen buffer, which includes both primary and supplemental content currently visible on a user device's display. This allows for more efficient use of screen real estate and better content prioritization.

Further, for example, a method adjusts secondary content (e.g., ads) based on remaining vertical or horizontal (e.g., and/or a third-dimensional direction, e.g., depth) screen space relative to the secondary content's boundaries. If the remaining space is below a certain threshold, the content of the secondary content (e.g., ad) is changed. This ensures that secondary content (e.g., ads) are displayed optimally for maximum visibility and impact.

In addition, for example, a method includes displaying a video in addition to primary content and adjusting the video's playout speed based on scrolling speed. It also controls responses in which a video embedded within the primary content goes beyond the screen buffer, displaying, e.g., a modified video based on an unfinished portion of the video in a picture-in-picture (PiP) window. This enhances the viewing experience by ensuring that video content is not missed due to scrolling.

Moreover, for example, a method dynamically adjusts the rendering of images in the content feed, particularly when the content feed is likely to fill a capacity of the screen buffer. This ensures that images are displayed optimally, enhancing visual appeal and reducing the likelihood of image cropping or distortion.

Furthermore, for example, a method considers various scrolling characteristics, including at least one of speed, acceleration, direction, a scroll depth, a bounce rate, a load time, a size of a feed buffer, a size of the screen buffer, a size of an available memory, an eye gaze characteristic, a touchscreen input, a scroll pattern, a user interaction via a user device, a scroll position, a time on a page, an end-of-scroll indicator, combinations of the same, or the like.

Additionally, for example, a method dynamically animates (e.g., using anchor points) supplemental content based on a scrolling characteristic of primary content being displayed, distance to one or more edges of a display, a scrolling speed, and a scrolling acceleration rate. This could include animating a character, a logo, an icon, or any other adjustable model by enacting, contracting, expanding, crouching, running, or sliding the character across the display screen. This adds an element of interactivity and visual interest to the content feed.

Still further, for example, a method considers external factors such as sensor readings and weather forecasts to dynamically animate supplemental content. This provides context-awareness. In some embodiments, the external factors, such as an inertial measurement unit (IMU), accelerometer, gyroscope data, or other external factors data, are retrieved from a user device.

Even further, for example, a method modifies supplemental content using seam carving, which includes cropping the supplemental content to remove at least one low energy seam, particularly in response to detecting a fast scrolling event. This ensures that determined (e.g., priority) parts of the content are preserved while fitting into the available screen space.

Yet further, for example, a method provides an infinite scroll environment for primary content being displayed, ensuring a seamless and uninterrupted browsing experience.

Further still, for example, a method includes video manipulation, image manipulation, or content creation as part of adjusting supplemental content in a content feed. This allows for a richer and more diverse content offering.

Methods are provided for generating a dynamic and responsive interface including adjustment of supplemental content based on various factors, such as scrolling characteristics of primary content, screen buffer size, remaining screen space, and external factors. These and related methods enhance user engagement, optimize secondary content (e.g., ad) display, improve video content control, and ensure optimal image rendering and content presentation.

These features, individually or collectively, contribute to a more engaging and effective presentation of secondary content on a display screen. Other similar features may also be included within the scope of this disclosure. Related devices, systems, formulas, non-transitory, computer-readable media, and the like are also provided.

The present invention is not limited to the combination of the elements as listed herein and may be assembled in any combination of the elements as described herein. These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings in which like reference numerals indicate identically or functionally similar elements, of which:

FIG. 1A depicts a first screen for an example process for adjusting supplemental content on a content sharing application before a condition is triggered, in which a first message and a first image are displayed when an upper edge of an advertisement is a first distance from an edge of a display area, in accordance with some embodiments of the disclosure;

FIG. 1B depicts a table of conditions, triggers, and changes associated with the example process of FIGS. 1A and 1C, in accordance with some embodiments of the disclosure;

FIG. 1C depicts a second screen for the example process for adjusting supplemental content on the content sharing application when the condition is triggered, in which a second message and a second image are displayed when the upper edge of the advertisement is a second (e.g., closer) distance from the edge of the display area, in accordance with some embodiments of the disclosure;

FIG. 2 depicts an illustrative diagram of an example structure of a social media feed that includes supplemental content, in accordance with some embodiments of the disclosure;

FIG. 3 depicts an illustrative diagram of an example structure of a social media feed that includes supplemental content, in accordance with some embodiments of the disclosure;

FIG. 4 depicts an example of a viewport configuration of a content sharing application comprising a supplemental content with a video that has been fully viewed, in accordance with some embodiments of the disclosure;

FIG. 5 depicts an example of a viewport configuration of a content sharing application comprising a supplemental content with a video that has been partially viewed, in accordance with some embodiments of the disclosure;

FIG. 6 illustrates an example process for contextually cropping an image to maintain determined (e.g., prioritized) features, in accordance with some embodiments of the disclosure;

FIG. 7 depicts an example process for changing a supplemental content based on the vertical screen space above or below the supplemental content, in accordance with some embodiments of the disclosure;

FIG. 8 depicts an example of a viewport configuration of a content sharing application comprising a supplemental content displayed in a PiP window, in accordance with some embodiments of the disclosure;

FIG. 9A depicts an example of a viewport configuration of a content sharing application comprising a supplemental content in a first state, wherein the supplemental content is changed based on a scrolling characteristic, in accordance with some embodiments of the disclosure;

FIG. 9B depicts an example of the viewport configuration of the content sharing application comprising the supplemental content of FIG. 9A in a second state, in accordance with some embodiments of the disclosure;

FIG. 9C depicts an example of the viewport configuration of the content sharing application comprising the supplemental content of FIGS. 9A and 9B in a third state, in accordance with some embodiments of the disclosure;

FIG. 10A depicts an example of a supplemental content on a content sharing application interface in a first state, wherein the supplemental content comprises of a dynamic animation that is changed based on a scrolling characteristic, in accordance with some embodiments of the disclosure;

FIG. 10B depicts an example of the supplemental content on the content sharing application interface of FIG. 10A in a second state, in accordance with some embodiments of the disclosure;

FIG. 11 depicts an example of a supplemental content on a content sharing application interface, wherein the supplemental content comprises of a dynamic animation that is changed based on an orientation characteristic, in accordance with some embodiments of the disclosure;

FIG. 12 depicts an example of a supplemental content on a content sharing application interface, wherein the supplemental content comprises of a dynamic animation that is changed based on environmental metadata, in accordance with some embodiments of the disclosure;

FIG. 13 depicts an example of a supplemental content on a content sharing application interface, wherein the supplemental content comprises of a dynamic animation that is changed based on a scrolling characteristic removing the supplemental content from the viewport, in accordance with some embodiments of the disclosure;

FIG. 14 depicts an example process for retrieving supplemental content through a real-time bidding process, in accordance with some embodiments of the disclosure;

FIG. 15A illustrates an example scenario of displaying supplemental content on a content sharing application using an AR/VR device in a first state, in accordance with some embodiments of the disclosure;

FIG. 15B illustrates the example scenario of displaying supplemental content on the content sharing application using the AR/VR device of FIG. 15A in a second state, in accordance with some embodiments of the disclosure;

FIG. 16A shows an illustrative process for adjusting supplemental content in a content feed based on scrolling characteristics and a characteristic of a screen buffer, in accordance with some embodiments of the disclosure;

FIG. 16B shows an illustrative process for adjusting supplemental content in a content feed based on a scrolling characteristic, in accordance with some embodiments of the disclosure;

FIG. 17 depicts an example of an artificial intelligence system, in accordance with some embodiments of the disclosure;

FIG. 18 depicts a communication system, in accordance with some embodiments of the disclosure;

FIG. 19 shows an illustrative process for changing supplemental content based on the amount of vertical screen space above and below the supplemental content, in accordance with some embodiments of the disclosure;

FIG. 20 shows an illustrative process for changing supplemental content based on the amount of horizontal screen space to the left and right of the supplemental content, in accordance with some embodiments of the disclosure;

FIG. 21 shows an illustrative process for adjusting video playout speed based on an identified scrolling speed, in accordance with some embodiments of this disclosure;

FIG. 22 shows an illustrative process for displaying video in a PiP window after it has left the screen buffer, in accordance with some embodiments of this disclosure;

FIG. 23 shows an illustrative process for adjusting video playout based on remaining time left in the video before being scrolled out of the screen buffer, in accordance with some embodiments of this disclosure;

FIG. 24 shows an illustrative process for stopping video play of a post and starting video play of a new post, in accordance with some embodiments of this disclosure;

FIG. 25 shows an illustrative process for adjusting supplemental content in content feed based on a scrolling characteristic, in accordance with some embodiments of this disclosure;

FIG. 26 shows an illustrative process for loading a complete video from a feed buffer into a screen buffer and adjusting the video based on a scrolling characteristic, in accordance with some embodiments of this disclosure;

FIG. 27 shows an illustrative process for replacing a first portion of a video content with a second portion of the video content and rendering the video content for display as an overlay of the second portion of the video, in accordance with some embodiments of the disclosure;

FIG. 28 shows an illustrative process for adjusting video content based on the position of the video content in relation to a viewport, in accordance with some embodiments of the disclosure; and

FIG. 29 shows illustrative pseudo code for an implementation of video playout, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

Methods and systems are provided for enhancing visibility of supplemental content, such as advertisements or media promotions, during consumption of primary content on a content sharing application, like social media. The methods and systems dynamically adapt presentation of supplemental content based on a user's interaction data, which could include scrolling behavior, viewing progress, watch history, and even the orientation of the user's device. One goal is to ensure that even if a user skips or scrolls past the supplemental content, it still gets some level of exposure. Increased exposure is achieved through various processes, such as modifying the content still within the viewport, playing videos in a PiP window, or overlaying dynamic animations on top of the social media feed. The methods and systems respond to changes in the device's orientation or environmental conditions. The methods and systems predict and respond to the user's scrolling speed and direction via the device, the size of the user's device, and the user's swiping behavior via the device.

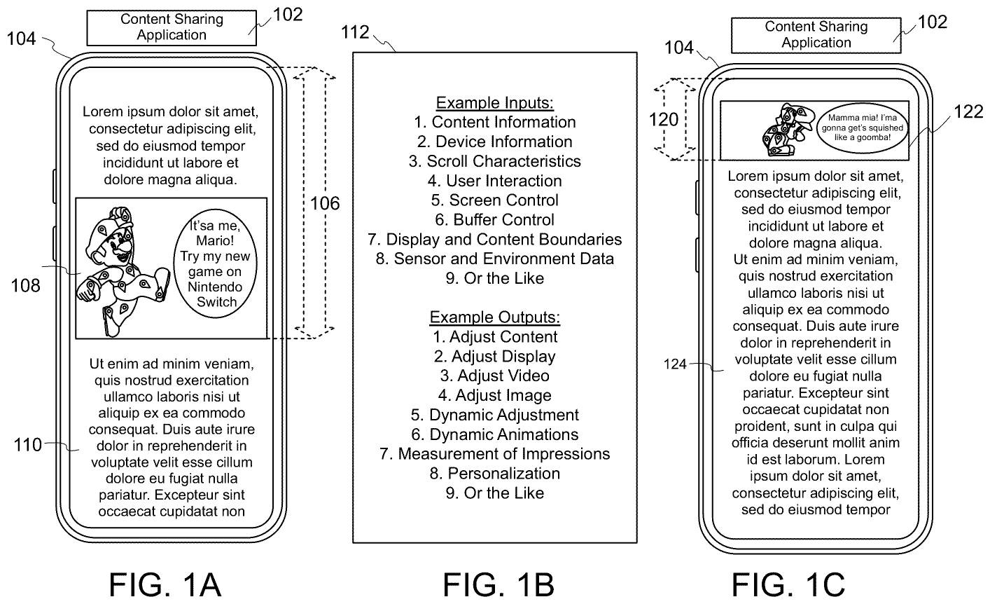

For example, exposure to supplemental content (e.g., media promotions, ads, or the like) is improved during consumption of primary content (e.g., social media content) through a content sharing application (e.g., social media platform). Also, for example, a system retrieves from a user device displaying the content sharing application, interaction data indicating a user's interaction with the content on the content sharing application. The interaction data may include scrolling data, viewing progress, watch history, impression data, orientation data, or other types of interaction data. The system may determine that the supplemental content may be skipped based on the interaction data and dynamically modify the supplemental content, as shown in FIG. 1.

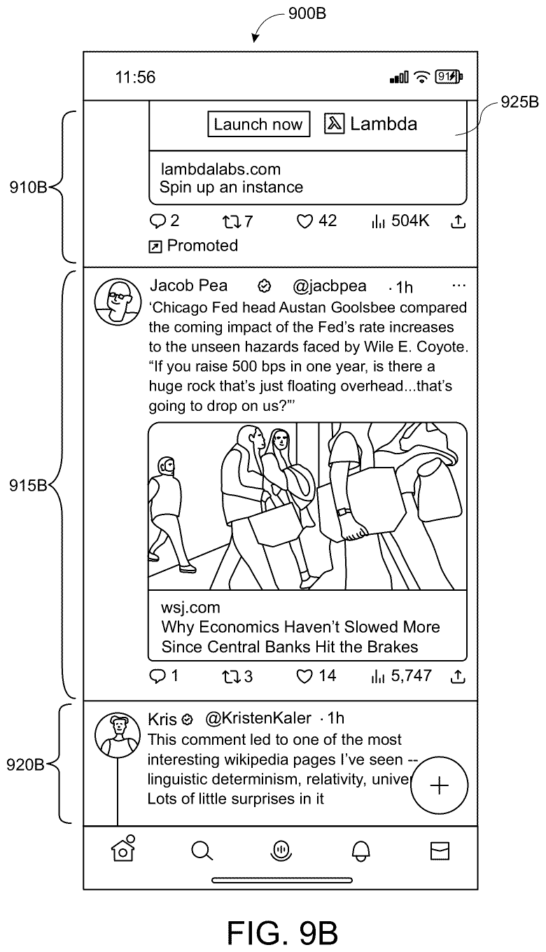

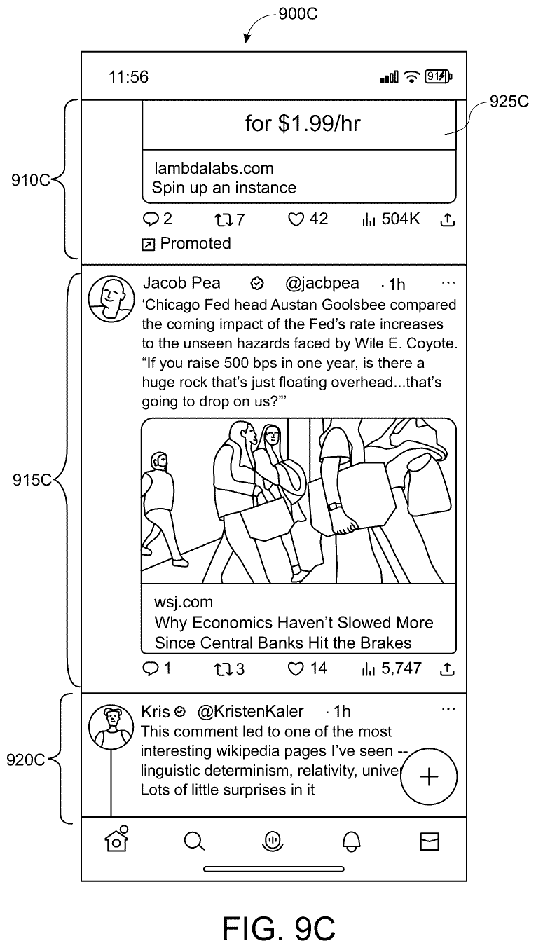

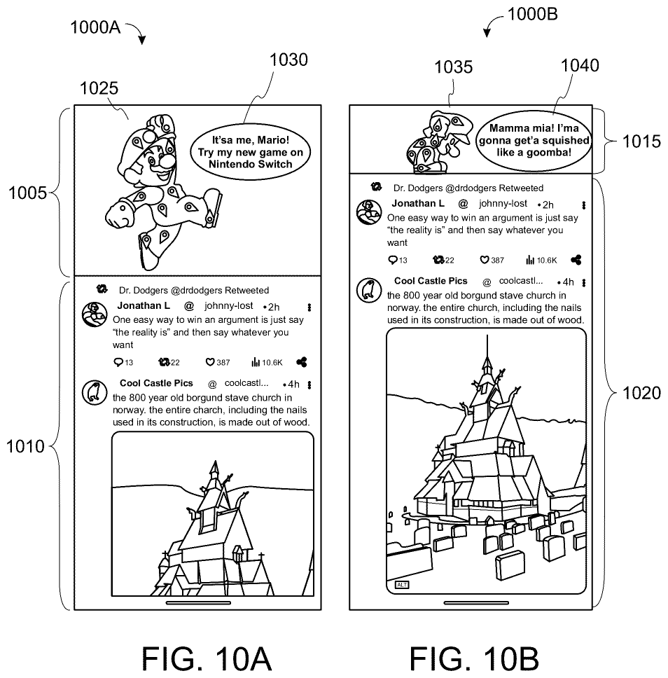

For example, the system may determine that the user, via the device, has scrolled past the supplemental content. The supplemental content may be partially still within the boundaries of the device screen or viewport. In some embodiments, the system may modify the portion of the supplemental content that is still within the boundaries of the device screen or viewport by modifying the text to be shown within the portion, such as shown in FIG. 9C. In some embodiments, the system may modify the portion of the supplemental content that is still within the boundaries of the device screen or viewport by modifying a dynamic animation or other media to update its animation parameters, such as shown in FIGS. 10A and 10B.

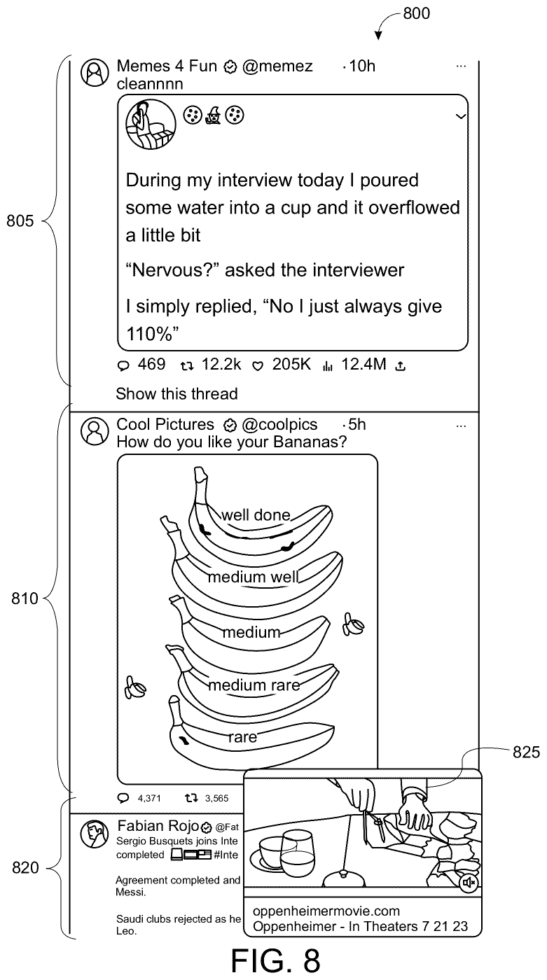

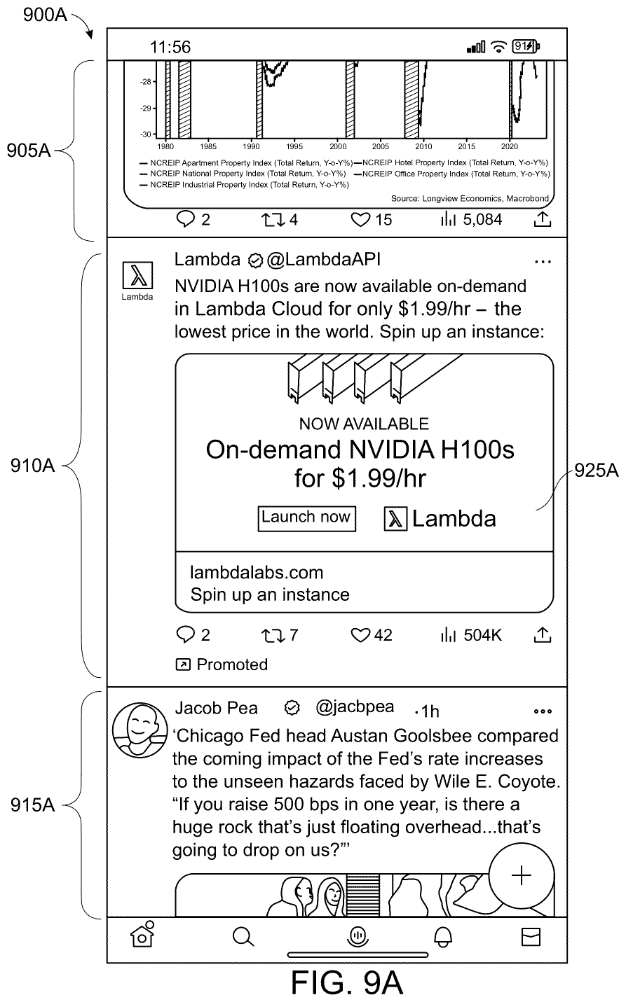

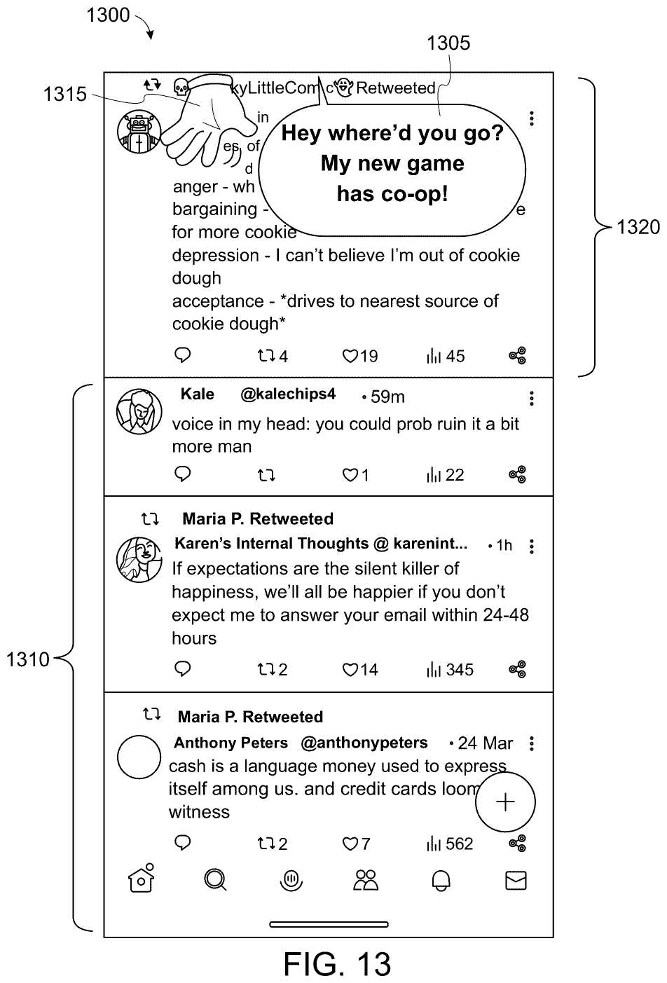

In another example, the system may determine that the supplemental content is no longer within the boundaries of the device screen or viewport. In some embodiments, the system may play a video that is no longer visible in the social media feed via a PiP window, such as shown in FIG. 8. In some embodiments, the system may overlay a dynamic animation or other media on top of the social media feed, such as shown in FIG. 13.

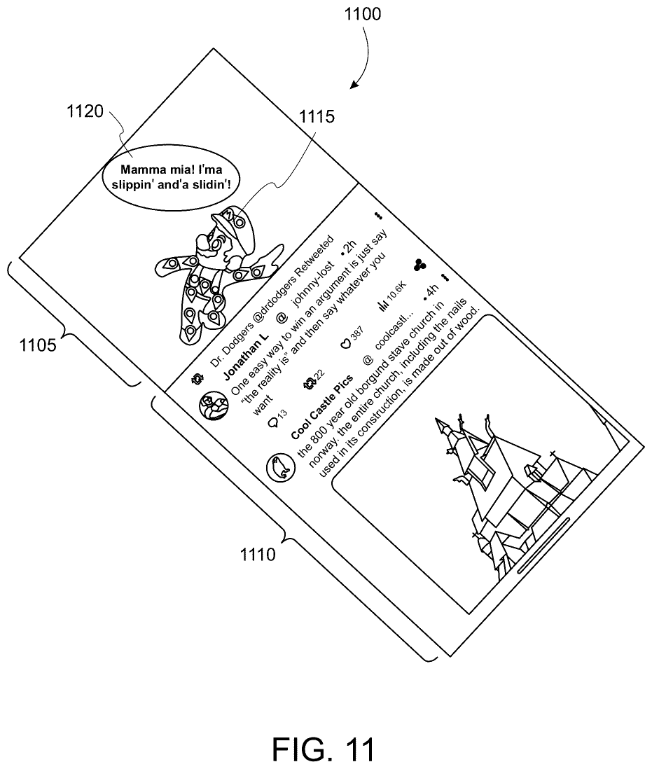

In another example, the system may determine that the user, via the device, is changing the orientation of the user device. The supplemental content may be dynamically modified to be level with the orientation of the user device, such as shown in FIG. 11.

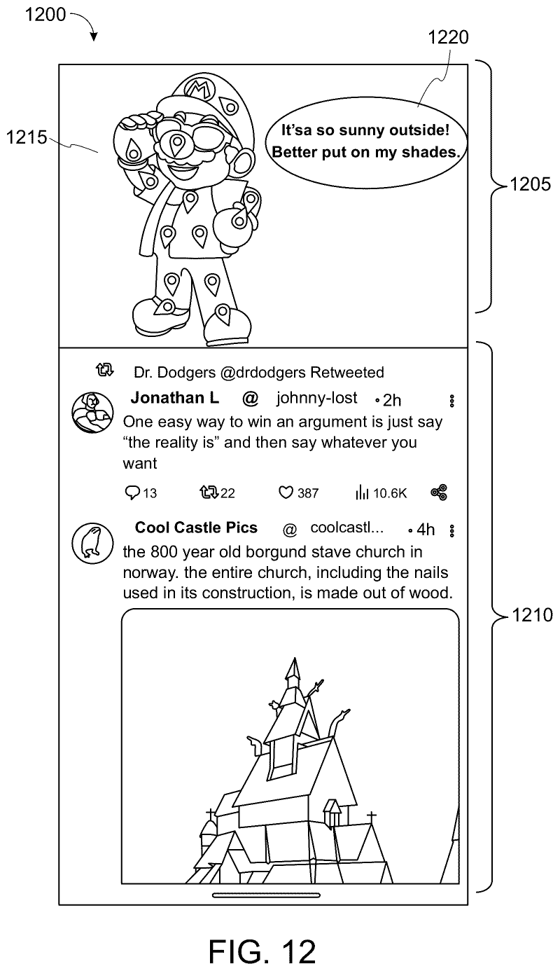

In another example, the system may retrieve environmental data from the user device, such as weather data. The supplemental content may be updated to react to the environmental condition, such as shown in FIG. 12.

In one embodiment, the size of social media posts preceding or following an ad may be used to predict how much of the ad will be cropped and modify the ad content in response.

As used herein, various types of buffers are discussed, including, for example, a screen buffer and a feed buffer. For example, the screen buffer holds content items that are visible to a user through a user device. The screen buffer is configured to display the content that the user can currently see on their screen. For instance, if a user is browsing a social media app, the screen buffer will contain the posts, images, or videos that are currently visible on the user's device.

Also, for example, the feed buffer manages a larger set of content items that are fetched and loaded into the screen buffer to maintain seamless scrolling. The feed buffer acts as an intermediary storage that helps to ensure smooth and continuous content delivery as the user scrolls through the app. For example, the feed buffer may load to the user device a plurality of content items (e.g., 100 items) from a larger database of social media posts. The user device may be configured to display only a subset of these content items at a time (e.g., five items), which depends generally on the size of the display and of the content items, and on scrolling characteristics. In this example, a subset of the plurality of content items from the feed buffer (e.g., 5 out of 100 items) is loaded into the screen buffer.

When the user scrolls to view more content, the screen buffer updates by removing the currently displayed subset of content items and replacing them with the next subset of content items from the feed buffer.

In another example, the user may have scrolled through all 100 content items in the feed buffer. This means that the screen buffer has sequentially loaded and removed each of the 100 content items onto the display screen. Once the user has viewed all the content items in the feed buffer (e.g., or a portion thereof, such as 80% of the content items), the user device sends a request for a second batch of content items to be loaded into the feed buffer.

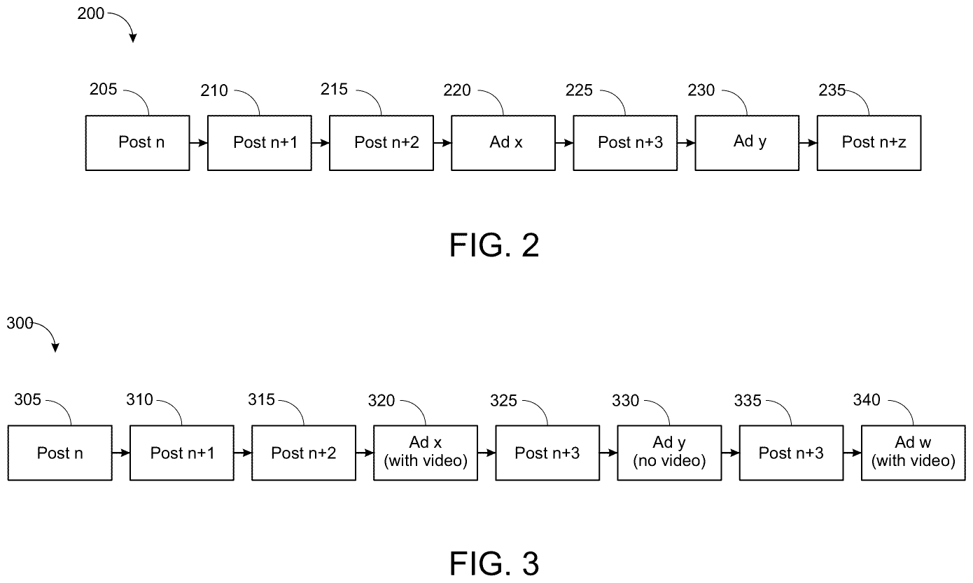

In some embodiments, the interaction data indicates that the user, via the device, is scrolling up/down and/or left/right of the social media feed. In order to support scrolling in both directions, the system will check a feed buffer and (e.g., as shown in FIGS. 2-3) compute which content (e.g., or a portion and percentage of a content) that will be in the screen buffer based on the speed of the scrolling in either direction. Since the feed buffer is sequential, the system has advance data indicating content that it will be inserting into the social media feed. The system may compute how much exposure a specific supplemental content media element (e.g., image or video) will have in the social media feed given the scrolling speed. In some embodiments, the system retrieves the size of the supplemental content to determine the size of space it will occupy on the screen buffer. In some embodiments, the system may also retrieve the length of a video in the supplemental content to calculate a portion of the video that will be seen given the scrolling speed.

In some embodiments, the system may adjust the video playout speed based on the scrolling speed, with respect to the other content in the feed.

In some embodiments, the system may determine the size of the user device on which the media sharing platform is running on to determine the exposure time for the supplemental content on the specific user device based on the display and/or viewport size.

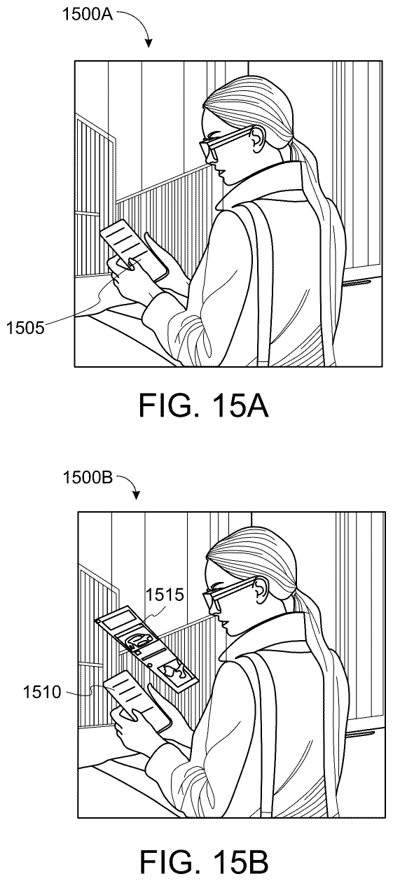

In another embodiment, the system may retrieve interaction data indicating that the user, via the device, is swiping up and/or down on the social media feed. In another embodiment, the system may retrieve interaction data indicating that the user, via the device, is swiping left and/or right on the social media feed. In some embodiments, the system may modify a supplemental content to be squeezed into a space towards the boundary of the display and/or viewport of the user device to provide a last gap exposure before the swipe operation is complete. In other embodiments, for devices that use a depth-based rendering such as AR/VR headsets, the system may provide extra exposure to supplemental content, such as shown in FIGS. 15A and 15B. For example, a user may be scrolling through media items using an AR/VR headset and scroll past a supplemental content. The AR/VR headset may display the supplemental content as an overlay stacked on top of the media items and continue the supplemental content playout until it is over or until a set period of time has passed. That is, for example, despite a user scrolling past promotional content on a main device, promotional content is stacked in an AR environment via a second device (e.g., a head mounted display (HMD)) so that the promotional content is still available for consumption in the AR environment. Also, for example, one or more PiP windows may be provided in the AR environment.

FIG. 1A depicts a first screen for an example process for adjusting supplemental content on a content sharing application before a condition is triggered, in which a first message and a first image are displayed when an upper edge of an advertisement is a first distance from an edge of a display area. FIG. 1B depicts a table 112 of examples of one or more inputs and one or more outputs associated with the example process of FIGS. 1A and 1C. FIG. 1C depicts a second screen for the example process for adjusting supplemental content on the content sharing application when the condition is triggered, in which a second message and a second image are displayed when the upper edge of the advertisement is a second (e.g., closer) distance from the edge of the display area.

A process associated with FIGS. 1A and 1C includes accessing the content displayed in a content feed, identifying a type of the content, and the type of device accessing the content, as well as predicting future content. The process also includes determining scrolling characteristics such as speed, acceleration, and direction, detecting fast scrolling events, and identifying user interaction patterns, including whether the user scrolls with their left or right hand. Buffer control for the screen buffer involves determining the size of the screen buffer, predicting when the screen buffer will run out of space or be filled, and tracking the position of videos within the screen buffer. Display and content boundaries are assessed by identifying the vertical and horizontal screen space around supplemental content, measuring distances to screen edges, and determining the display's form factor and whether multiple displays are used. Video and media interaction involves checking if a post contains video, whether the post is playing, accessing the current play timestamp, and predicting when new posts with video will appear. Finally, sensor and environmental data are gathered from various sensors, including light sensors, accelerometers, gyroscopes, and magnetometers, as well as accessing weather forecasts.

The process involves adjusting supplemental content in the content feed based on factors like scrolling characteristics, screen buffer size, and the primary content likely to be displayed. The process includes changing the content of the supplemental content based on vertical and horizontal screen space, providing an infinite scroll environment for the primary content, alternating or interspersing the primary content with the supplemental content, and rearranging the supplemental content based on a viewing time.

As used herein, the viewing time is determined in one of several ways in various embodiments. For example, the viewing time includes a sequential time the supplemental content is viewable by a user via a user device on the screen. Also, for example, the viewing time includes a period during which the supplemental content is accessible on a user's device. Further, for example, the viewing time includes an engagement time. In addition, for example, the engagement time includes determined using analytics processes. Moreover, for example, the engagement time includes a measurement of how long a user is actively interacting with the supplemental content. Furthermore, for example, the viewing time includes an amount of time scrolling has stopped. Additionally, for example, the viewing time includes an amount of time a video is playing. Still further, for example, the viewing time is measured by an eye tracker. Even further, for example, the viewing time is a time that at least a portion of the supplemental content resides in a screen buffer. Yet further, for example, the viewing time is a length of a supplemental content video. Also, for example, the viewing time is, for a video, a percentage of a total duration of the video. Further still, for example, the viewing time includes the definitions above as applied to the primary content or both the primary content and the supplemental content.

In some embodiments, based at least in part on a determination that the viewing time is below a predetermined threshold, a modification and/or duplication of the supplemental content is presented at another point in time. For example, an advertiser selects a target of a six second threshold for consumption of the supplemental content. When the viewing time is less than the six second threshold, the supplemental content (e.g., a video) is queued up in a subsequent portion of the infinite scroll content.

Video and image manipulation steps include adjusting video playout speed based on scrolling speed, displaying a modified video in a picture-in-picture window, starting, stopping, and updating video play, and performing various video and image editing tasks such as speeding up videos, cropping images, creating animations, and adding text overlays. Dynamic adjustments and animations involve dynamically adjusting the rendering of images in the content feed, animating supplemental content based on scrolling characteristics, sensor data, and weather forecasts, and animating characters on the display screen. Content modification techniques include modifying supplemental content using seam carving and cropping to remove low energy seams. Measurement and personalization steps involve measuring impressions during the adjustment of supplemental content, personalizing scrolling characteristics and adjusting supplemental content based on user profiles, storing scrolling patterns and hand preferences, and generating supplemental content segments with approximately the same duration of exposure.

Processes and systems are provided for adjusting supplemental content 108 on a content sharing application, such as social media platform 102, when a condition is triggered. Content sharing application 102 may send to user device 104 a display of content including supplemental content 108 and other primary content 110, such as posts from users on the content sharing application, surveys, messages, images, videos, links, articles, live-streams, other promoted media, or a combination thereof. For example, content sharing application 102 may send an advertisement for a Mario video game for display on user device 104.

In some embodiments, a system is provided for adjusting advertisements in a content feed based on user interaction and scrolling behavior. The system receives data on conditions such as vertical space between ads and social media posts, inserted ads, scroll speed, and scroll direction. The system uses, for example, one or more triggers. The one or more triggers include, for example at least one of an amount of vertical space between an ad and an upper limit of a screen, a size of an ad, a scroll speed, a predicted user interest, a device orientation, one or more device application programming interface (API) triggers, a determination of a saliency of an ad, eye tracking information, combinations of the same, or the like. Also, for example, the eye tracking information includes at least one of an analysis of eye tracking information to determine an interest in displayed content, eye tracking within an ad, eye tracking between an ad and other types of displayed information, combinations of the same, or the like. These triggers help determine when and how to adjust the ads. Based on the input and processing, the system can change the size of the screen buffer, the orientation of the ad (e.g., tilt), and the text of the ad. This dynamic adjustment aims to enhance user engagement and ad effectiveness.

In some embodiments, supplemental content 108 is adjusted based on conditions being triggered 116, such as a change in the amount of the display size, a scrolling speed determined to be above a threshold, a change in the size of the promoted content, a determination of user interest in the supplemental content, a determination of the size of the screen buffer, other indicators of user interaction with the content sharing application, or a combination thereof. For example, content sharing application 102 identifies an amount of space bordering one or more boundaries of the display. Also, for example, content sharing application 102 receives scrolling data from user device 104 indicating that a user is scrolling through a social media feed. Further, for example, content sharing application 102 determines that the space 106 above supplemental content 108 is, as the user scrolls, shrinking to a size of a vertical space 120. In addition, for example, content sharing application 102 determines that the size of the vertical space 120 is not sufficient to display the entirety of primary content 108. Moreover, for example, a process adjusts the supplemental content such as at 122 to display the supplemental content in relatively less space, and the other primary content 110 in relatively more space, e.g., as shown at 124 of FIG. 1C.

In some embodiments, supplemental content 108 is adjusted by changing the size of the primary content. For example, an advertisement on the social media feed may stay within the viewport of the device, but the content shrinks in size as the user, via the device, scrolls up.

In some embodiments, supplemental content 108 is adjusted by changing the text of the primary content. For example, an advertisement on the social media feed may change the text in the advertisement to become more condensed or concise as the user, via the device, scrolls up like as shown in FIGS. 9A-9C. In some embodiments, text from supplemental content 108 may be condensed by generating a summary of the text, emphasizing certain words of phrases of the text, or shortening the text to display only the first couple words, among other methods to display a smaller portion of the original text.

In some embodiments, supplemental content 108 is adjusted by changing the orientation of the supplemental content with respect to the primary content as shown in FIG. 11. For example, an advertisement on the social media feed may change the content of the advertisement to mirror the change in orientation of the user device. Also, for example, an animation in a supplemental content may be adjusted to look like it is sliding at an angle based on the change in orientation of the user device like as shown in FIG. 11.

In some embodiments, the system comprises of a feed buffer for social media content items. The feed buffer constitutes posts being pulled out of the server by the client and cached on the device, either on the browser or the app. Once the feed buffer is empty, it is refreshed from the server. If a social post has an embedded video, video content is also buffered to enable instant playout.

In some embodiments, the system comprises of a screen buffer. The screen buffer consists of the posts that are now visible on the browser or the social media app page structure.

In some embodiments, a particular social post may be in the feed buffer and may not be in the screen buffer, meaning it has not yet been rendered for display and is kept within the cache of the browser or app.

In some embodiments, the number of posts that can fit within the screen buffer varies due to the varying size of the posts and other conditions like the type of content included in the post, such as text, media, video, poll, document, emoji, etc. In some embodiments, a single post can occupy the entire screen buffer and be displayed over the entire screen page. In other embodiments, multiple posts may occupy the screen buffer and are displayed chronologically in the screen page. In some embodiments, a post may have a larger size than another post. In some embodiments, a screen buffer may have multiple posts correlating to a display of the multiple posts over the screen page. However, a device may send a request to expand on a post in the screen buffer. For example, the system may receive a request from the device to expand on text that has been hidden, opening to read a list of comments of the post, or in other ways expanding a post to a size bigger than the original post. The screen buffer may be adjusted based on the expansion of a post. In some embodiments, the expansion of a post may result in that post being the only post in the screen buffer. In other embodiments, the expansion of a post may result in removing other posts from the screen buffer.

FIGS. 2-3 show an illustrative diagram of a structure of social media feeds 200 and 300 that include supplemental content 220, 230, 320, 330, and 340. Social media feed 200 comprises of primary content 205-235. Social media feed 300 comprises of primary content 305-340. In some embodiments, social media feeds 200 and 300 may be loaded into a feed buffer by a media sharing system, such as a social media platform. The media sharing system receives primary content 205-235 and 305-340 from user profiles associated with the content sharing application. Primary content 205-235 and 305-340 may be received from different user profiles associated with the content sharing application. For example, primary content 205-235 and 305-340 may be social media posts uploaded to the content sharing application by user profiles using different user devices. Supplemental content 220, 230, 320, 330, and 340 may be received from an ad exchange via a supply side platform (SSP). For example, promoted media 220, 230, 320, 330, and 340 may be advertisements received from advertisers through a demand side platform (DSP) and stored in an ad inventory on an ad exchange. In some embodiments, in addition to the SSP and/or the DSP, a source of ads includes at least one of an agency trading desk (ATD), a data management platform (DMP), a customer data platform (CDP), an ad measurement platform (AMP), programmatic advertising platforms (e.g., automated buying and/or delivery of ad space, e.g., in social media), combinations of the same, or the like. In some embodiments, supplemental content may include video such as in primary content 340. In other embodiments, supplemental content may include interactive media such as text overlay, PiP, polls, quizzes, games, audio, augmented reality (AR) experiences, interactive infographics, interactive email, interactive maps, live-streams, dynamic animation, and other types of interactive media, or a combination thereof.

In some embodiments, social media feeds 200 and 300 are stored in a database on a server. In some embodiments, the media sharing system adds new primary content received from user profiles into the server database. In some embodiments, the content sharing application sends primary content from the server database to be cached on a feed buffer on a user device, such as on a browser or an app. The primary content in the feed buffer may be divided into loads of the same load size. For example, the feed buffer may comprise of loads with load sizes of 20 primary content each. In that example, the initial load of feed would be the first 20 primary content in the feed buffer. In some embodiments, the primary content in the feed buffer may be organized based on the chronological order in which the primary content was received. For example, a first primary content received by the content sharing application from an upload by user profile A at 8 am is higher in the feed buffer than a second primary content received by the content sharing application from an upload by user profile B at 8:20 am. In yet another example, a first primary content received by the content sharing application at 8 am from a user profile is higher in the feed buffer than a second primary content received by the content sharing application from the same user profile at a later time.

In some embodiments, the feed buffers for social media feeds 200 and 300 may be initially empty. The feed buffer may refresh and pull from the server database an initial load of a load size of primary content. For example, upon initialization of the content sharing application on a user device, the feed buffer may pull 20 pieces of primary content from the content sharing application server to store in a cache on the user device.

In some embodiments, system 200 may load primary content 205-235 in a feed buffer accessed by a content sharing application running on a user device. The feed buffer may include a tag or a trigger at the end of the cache that triggers an operation to reload the feed buffer with new primary content. As such, system 300 and primary content 305-340 correspond to system 200 and primary content 205-235.

In some embodiments, the user device caching the feed buffer of primary content may also cache a screen buffer on the device's local memory. The screen buffer dynamically allocates primary content within a viewport of the screen of the user device. The user device may send display metadata to the content sharing application such as data associated with display size, display resolution, thresholds representing the percentage of a primary content that is visible within the viewport, display boundaries, tag data, trigger data, and other methods.

In some embodiments, at least one of primary content 220, 230, 320, 330, or 340 may be supplemental content such as advertisements. In some embodiments, the supplemental content may include video, such as with primary content 320 and primary content 340.

In some embodiments, the system determines that the size of a content is equal to or more than the size of the device screen or viewport. For example, a post can occupy almost the entire screen or page. In another example, multiple short posts can coexist in a single screen or page. The system may shorten the content that has a size equal to or more than the size of the device screen or viewport by abbreviating the text, modifying an image in the post, or modifying the content to become a smaller size, as shown with content 405. For example, the system may abbreviate part of a long post and add a button labeled “See More” that will reveal the rest of the post when clicked on. When the button is clicked on, the size of the post expands to its original size.

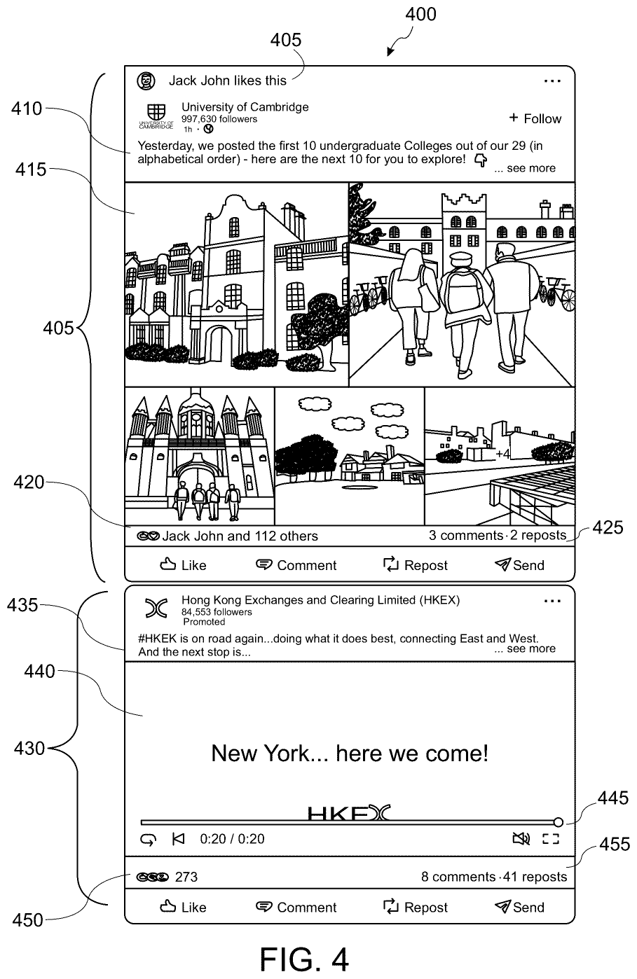

FIG. 4 shows a viewport configuration 400 of a content sharing application consisting of primary content 405, and supplemental content 435 with a video 440 that has been fully viewed, as shown in a scrub bar 445 superimposed over the video 440. The primary content may be posts, updates, featured content, engagement metrics, sponsored content, recommended content, suggested content, profile updates, messages, notifications, another type of social media or a combination thereof. In some embodiments, primary content is uploaded to the content sharing application through user profiles. For example, primary content 405 is uploaded to the content sharing application by a user profile of the University of Cambridge 410. In some embodiments, primary content may comprise additional media such as text, audio, images, videos, links, articles, blogs, comments (e.g., at 425 and 455), likes (e.g., at 420 and 450), reposts (e.g., at 425 and 455), other interaction indicator, or a combination thereof. For example, primary content 405 comprise of images 415 of undergraduate colleges in the University of Cambridge.

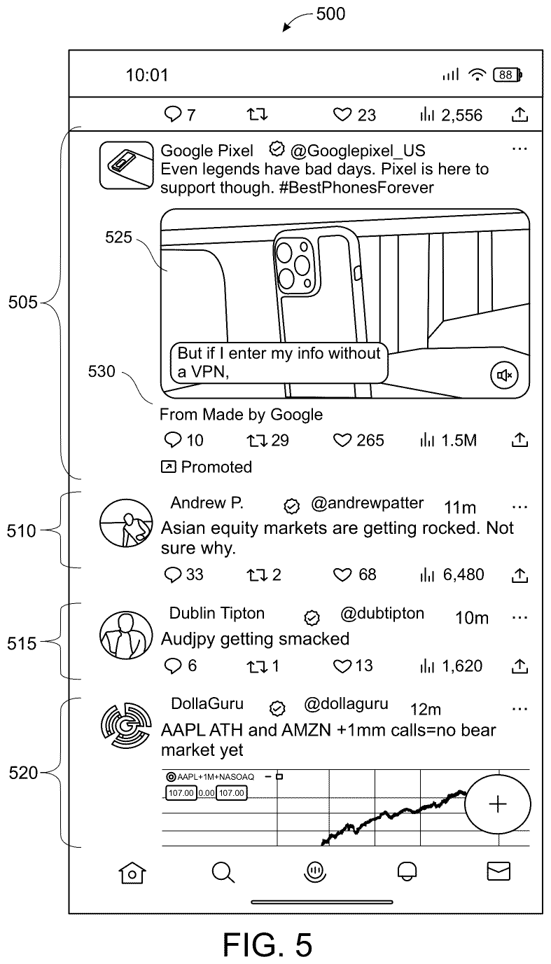

FIG. 5 shows a viewport configuration 500 of a content sharing application comprising one or more content items 505, 510, 515, 520 with supplemental content, e.g., a video 525, that has been partially viewed.

It can be seen in FIG. 4 that the promoted primary content from Hong Kong Exchanges and Clearing Limited (HKEX) has been viewed and that about 20 seconds of the video has been completed since there was no scrolling when this ad was played out. This means the user, via the device, was interested in this content. FIG. 5 demonstrates an advertisement for “Google Pixel” incorporating the video 525 and including an identifier 530 (e.g., “From Made by Google”). However, as the user, via the device, scrolls down, only a portion of this video is viewed due to the user's rapid scrolling pace, via the device, referred to here as a “fast scrolling” event. This does not necessarily indicate a lack of interest in the ad on the user's part, via the device. It could be that the video was too lengthy, or perhaps the user, via the device, was distracted by the subsequent post. If the user, via the device, continues to scroll down, pushing the ad out of the visible screen space, the user, via the device, will not see the remaining sections of the video. Consequently, the video player will pause, and the user, via the device, will not fully receive the marketing message. Despite this, the measurement unit may still count this ad as viewed within the social media feed. However, it is evident that the user, via the device, has not watched the entire video.

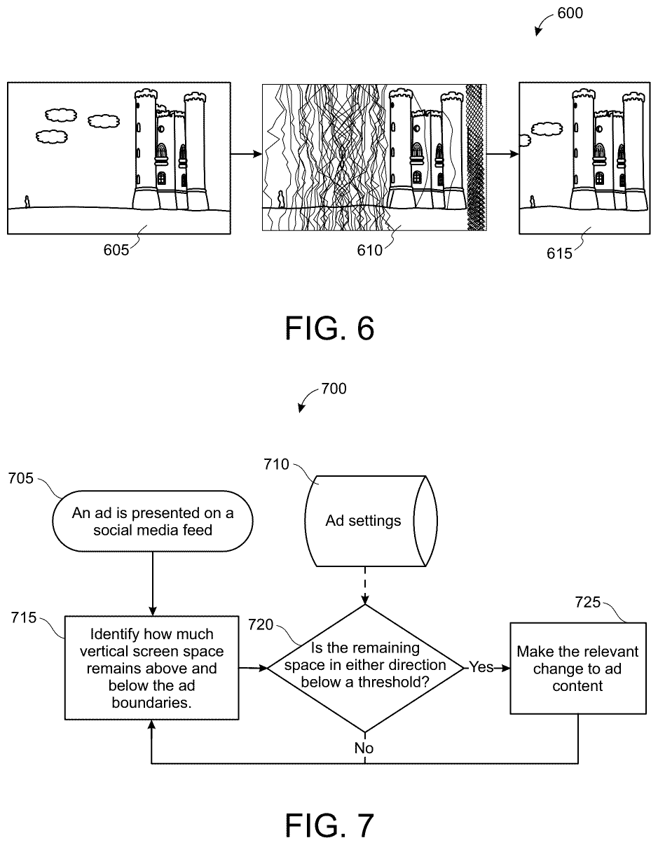

FIG. 6 presents an illustrative process 600 for the contextual cropping of image 605, designed to preserve determined (e.g., prioritized) features 610. Techniques, such as seam carving, facilitate intelligent and context-aware cropping of images, thereby preserving selected and/or determined features. The application of such enabling technology can enhance the effectiveness of cropped advertisements. FIG. 6 elucidates how seam carving identifies and utilizes determined (e.g., prioritized) visual regions for image cropping. This technology operates both vertically and horizontally (e.g., and/or in a third-dimensional direction, e.g., depth, for applications such as AR/VR). Seam carving processes the uncropped image 605, computes “seams” 610 based on visual features, and eliminates low-energy seams to produce the cropped image 615.

Furthermore, seam carving can be integrated with multiple pieces of content that have varying dimensions in terms of height and width. For example, seam carving includes generating a smaller version of supplemental content. Also, for example, when a user, via a user device, scrolls horizontally, the user may first see image 605. As the user scrolls, and an object in the image would otherwise move beyond a side of the screen, the image 605 is replaced with 615 so as to fit in the remaining space. That is, for example, a “seamless” seam carving process generates multiple seamed versions by modulating the energy level cutoff. Further, for example, seam carving achieves an animation kind of effect.

In some embodiments, a supplemental content may have been scrolled to a boundary of the device screen or viewport. The primary content may have been modified to keep determined (e.g., prioritized) features even though a percentage of the primary content is no longer visible on the display. In some embodiments, the primary content comprises an image. The system may input the image into a seam carving algorithm to output a modified image with a reduced image size yet still keeping the determined (e.g., prioritized) features of the image. For example, a social media post of an advertisement advertising a new Mario video game may have an image from a scene of the video game. When the image is scrolled beyond the boundaries of the device screen or viewport, portions of the image that do not have the character Mario in it are carved out so that the remaining modified image is still displaying Mario.

FIG. 7 depicts an example process 700 for changing a supplemental content based on the vertical screen space above or below the supplemental content. At 705, a supplemental content (e.g., an advertisement) is loaded into a display or screen buffer and presented on a social media feed displayed on a user device. At 715, the system identifies how much vertical screen space remains above and below the boundaries of the supplemental content. At 710, the system retrieves settings data associated with the supplemental content. The settings data may include instructions to dynamically modify the supplemental content if a condition is triggered. For example, settings data may include a size threshold that will trigger the supplemental content to be modified to fit the smaller size. At 720, the system determines whether the remaining space in either direction is below the size threshold. At 725, in response to determining that the remaining space in either direction is below the size threshold, the system makes relevant modifications to the supplemental content. If no condition is triggered, the supplemental content remains unmodified.

FIG. 8 depicts an example of a viewport configuration 800 of content sharing application comprising social media posts 805, 810, 820, and supplemental content 825 displayed in a PiP window.

In some embodiments, the system determines that the video in the supplemental content was unfinished before it was pushed out of the screen buffer. The system may display the remainder of the unfinished video in a PiP window, such as shown at 825. In some embodiments, the playout of the unfinished video in the PiP window is accelerated to an adjusted speed. In some embodiments, the accelerated adjusted speed is based on the determined scrolling speed. In other embodiments, the unfinished video is played at an accelerated adjusted speed until a second supplemental content with video appears in the screen buffer and displayed on the content sharing application feed. Also, for example, a portion of an unfinished video is selected, and played instead of playing an entirety of the unfinished video. Further, for example, based on a scrolling speed and one or more upcoming stacked items beyond a screen buffer, a duration of a video clip is determined. In addition, for example, the duration is set to be sufficient length for replacement by another autoplay video in a feed. Moreover, for example, the duration is utilized to extract and/or generate and/or alter a video for play in a PiP window.

Despite the lack of a standard post size, the social media platform, based on the screen buffer, possesses data indicating whether a specific post is visible on the screen. Furthermore, if it determines if the video segment is visible, and determines whether to halt the video decoder to render the video if it is not.

For example, a determination is made whether a current advertisement video playout remains within the screen buffer. If it does, the scrolling speed will be calculated and the video playout speed adjusted to ensure the current playout is expedited. This ensures the entire video playout is completed before the post scrolls up out of the screen buffer. If subsequent posts do not contain embedded videos, a PiP will be rendered towards the bottom of the feed to playout the remaining unplayed segments of the video. However, a calculation is made when the next post with an embedded video is entering the screen buffer, and playout speed of the previous video is adjusted to ensure that the video is completed before the next embedded video begins its playout. In some embodiments, the social media platform may delay the next embedded video so that the current video can continue playing without playback speed alteration.

The pseudocode provided below describes an algorithm for controlling video playback in a scrolling feed. The algorithm operates in a continuous loop, constantly checking if the user, via the device, is scrolling through the feed. If the user, via the device, is scrolling, the algorithm performs several actions to control the feed and video playback.

For example, first, it checks if the feed buffer is empty. If it is, the algorithm refreshes the feed buffer and renders post X from the feed buffer. If post X contains a video, the algorithm initiates the video playback.

The algorithm then checks if a video is currently playing. If a video is playing, it calculates the scrolling speed (S). If video post X is still in the screen buffer, the algorithm checks the current video playback timestamp (C1) and calculates the remaining time for Video X's playback based on the scrolling speed. It then adjusts video X's playback based on the remaining time and the current timestamp.

If video post X is not in the screen buffer, the algorithm calculates the time when a new post Y with a video will render based on the scrolling speed. It checks the current video playback timestamp (C2) and if the new post Y contains an embedded video, it stops the video playback of X (e.g., if the device cannot have two active video decoders at the same time) and starts the video playback of Y. If the new post Y does not contain a video, it creates a PiP window for X and adjusts Video X's playback based on the remaining time and the current timestamp.

This algorithm ensures a smooth and uninterrupted video playback experience for the user, via the device, while scrolling through the feed. It dynamically adjusts video playback based on the user's scrolling speed, via the device, and the content of the feed. This allows for optimal video viewing and minimizes interruptions due to buffer underflows or changes in the feed content.

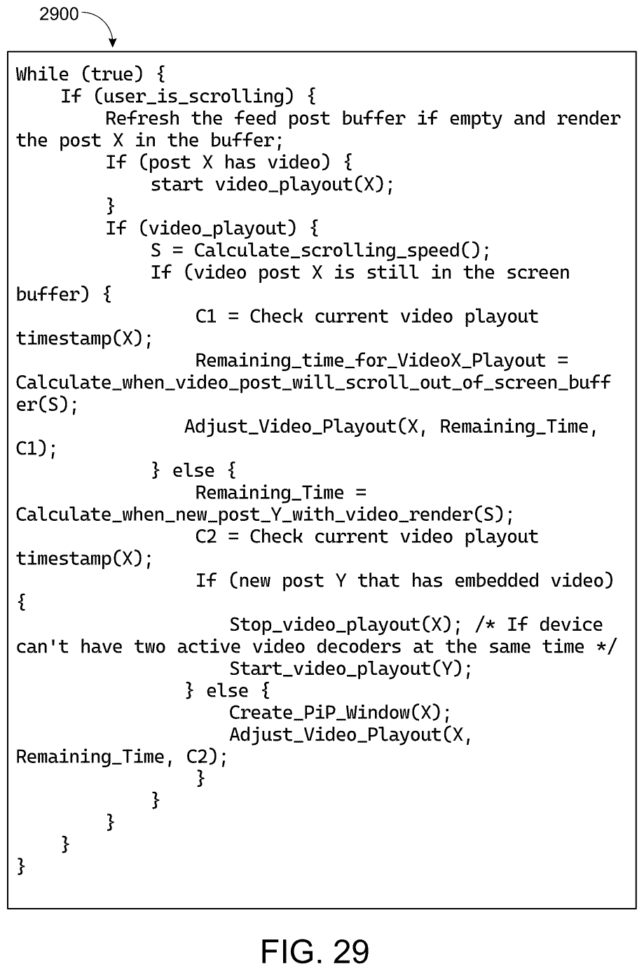

The pseudo code 2900 shown in FIG. 29 describes an example implementation. The scrolling speed can, for example, be calculated by dividing the total number of pixels scrolled by the total number of seconds. This speed is measured in units of pixels per second. In certain embodiments, the scrolling speed can be measured. For example, a media application controls what is displayed. As such, the media application has access to scrolling information such as how many pixels are sent up or down based on an input. Also, for example, scrolling speed may be measured by invoking a driver API code of firmware of an input device (e.g., a mouse, a touchscreen, or any other input device). In a concurrent multi-programming environment or operating system, the scrolling speed value, denoted, for example, as “S” in the pseudo code above, is dynamic. It can be computed in one thread (Thread A) and passed to another thread (Thread B) that is executing the aforementioned pseudo code.

In some embodiments, a scroll speed is averaged within a sliding window (e.g., instead of an average for a session). That is, scrolling does not necessarily have a consistent speed. In some instances, a user via a user device, may flick the screen, which results in a relatively fast movement that slows down, and without additional input, stops. Or, the user, via the user device, keeps scrolling with a scroll and/or slow pattern. Of course, other scrolling and consumption patterns are contemplated, e.g., the user, via the user device, waits for scrolling to stop before directing attention to newly visible posts; and/or, e.g., the user, via the user device, stops scrolling by putting a finger or stylus down before engaging (e.g., reading) or inputting more scroll commands. Predictions are configured to take into consideration various types of scrolling and consumption behavior.

As depicted in FIG. 8, the embedded video of the Oppenheimer movie advertisement, labeled as 825, is displayed in a PiP window at the bottom of the social media feed screen buffer. In some embodiments, if a user presses the red X indicator, the player will close. In other embodiments, if a user double-clicks on the player window, it may be interpreted as the user, via the device, expressing renewed interest in the post that is currently outside the screen buffer. The social media feed may then revert and slide back up to the original promotional movie social post. In some embodiments, a secondary window in the PiP can enable auto-hide and auto-pause features for the advertisement video when the user, via the device, selects an image or video from a post, which then occupies the full screen for viewing. This prevents a compromised experience where content is blocked. In some embodiments, the PiP can be automatically recovered when it is detected that the user, via the device, has returned to the posts. There is a nuanced difference between the concept above and a conventional “sticky” advertisement. The former is just the video and is only rendered until the next advertisement or content that has an embedded video, rather than being sticky regardless of a condition.

In another embodiment, instead of playing the entire unplayed portion of the video, only certain portions of the video are played depending on the remaining time available before the next post that contains an embedded video. In some embodiments, these certain portions of the video may be identified by receiving input that selects I-Frames of the remaining video or by receiving metadata indicative of an input that selects portions of the video. In other embodiments, the playout time, or the remaining available time, does not have to be sequential. For instance, the video playout may immediately jump to the end if the intended promotional message of the video is at the end of the video. If the advertisement video was deliberately constructed to have the intended promotional message in the middle of the video, the selected portions of the video intervals can be customized for the adjusted accelerated playout.

Depending on whether and when the user, via the device, double-clicks on the video to revisit the advertisement post again, the advertisement campaign can collect measurement data as to what specific time interval in the video prompted the user, via the device, to revisit the advertisement post. This measurement data can be analyzed to identify the portions of the video that received the most attention from the user, via the device. Such data can be leveraged specifically to readjust the video playout speed based on the scrolling speed so that the playout can focus only on those intervals of the video in which the user, via the device, expressed high interest, based on the aforementioned click data. In some embodiments, measurements for accelerated video playout impressions (e.g., due to scrolling speed), longer duration impressions based on the videos completed in a PiP window, and instances where the advertisement post was revisited may be collected into measurement data and computed granularly.

It is also feasible to collect micro-impression data for the portions of the video that were played at normal speed versus those that were played at an accelerated rate. This data collection can also include the time intervals of the video that received more attention from the user, via the device.

In some embodiments, multiple versions of supplemental content are created, for example, in durations of about 2, about 5, about 10, and about 30 seconds. This allows for the selection of an appropriate version to fit the playout duration that is predicted based on the user's behavior, via the device.

In another embodiment, scrolling can be accomplished via various interfaces such as eye gaze tracking, touch screen, touch pad, remote controller, head tracking, or periodic swiping on a device such as an Oura ring, in addition to the mouse.

In one embodiment, if the video portion of the advertisement has not been completed, scrolling can be slowed or temporarily disabled until all of the video or selected portions and/or shorter versions (e.g., as pre-customized by the advertiser) of the video have been viewed by the user, via the device.

In another embodiment, if the advertisement post includes an image rather than a video, as scrolling continues, before the post scrolls out of the screen buffer, the most prominent feature (e.g., as determined by the advertiser) in that image can be selected via segmentation. That segment of the image will then be zoomed in or magnified to enable a better impression of the advertisement image until it disappears. FIG. 9A shows the original appearance of the advertisement, and FIGS. 9B and 9C shows its appearance later when it is scrolled up.

FIG. 9A depicts an example of a viewport configuration 900A of a content sharing application comprising a supplemental content (e.g., 905A, 910A, 915A) in a first state, wherein a portion 925A of the supplemental content is changed based on a scrolling characteristic. FIG. 9B depicts an example of the viewport configuration 900B of the content sharing application comprising the supplemental content of FIG. 9A in a second state, where a top portion of the content 910A from FIG. 9A is now beyond view, i.e., beyond a top edge of the screen shown in FIG. 9B. However, in FIG. 9B, a portion 925B of the supplemental content is retained in the viewport configuration 900B. The supplemental content 915A from FIG. 9A is now shown in its entirety (e.g., 915B). Another supplemental content 920B is displayed at the bottom of the screen.

FIG. 9C depicts an example of the viewport configuration 900C of the content sharing application comprising the supplemental content of FIGS. 9A and 9B in a third state. As shown in FIG. 9C, only a portion 925C of the supplemental content 910C related to the price section of the advertisement is displayed and magnified in order to fit into the visible section of the supplemental content before it is removed from the screen buffer. The system determines portions of the supplemental content that have a higher importance value than other portions of the supplemental content to be displayed in the visible section before being removed from the screen buffer. The supplemental content 915B and 920B are unchanged as compared to FIG. 9B.

In some embodiments, the system can create multiple versions of the supplemental content at different sizes (for example, 720×480, 720×240, 720×120, 720×60, and so on). The system can select and display an appropriate version from these multiple versions according to the space available on the screen when the user, via the device, is scrolling through posts. These multiple versions can be included in a single image file for efficient switching when desired. Furthermore, for example, image sizes may not necessarily transition from one size to another in a stepwise manner, but may dynamically stretch by incrementally adjusting the image size in proportion to the scrolling activity. This creates a squeeze or rubber band effect, which aims to increase the user's interest in the advertisement, via the device.

In another embodiment, the system can provide alternate “last gasp” versions of supplemental content with varying durations (for example, about 0.25 seconds, about 0.5 seconds, about 1 second, about 2 seconds, or the like). The appropriate length of the advertisement version is chosen according to the predicted viewing time based on the scroll speed when the advertisement is presented.

In some embodiments, the aforementioned methods can be applied to social media application feeds that switch from one post to another post via a swipe up and/or left or down and/or right operation.

In one embodiment, the social media application presents posts of a certain length to increase the likelihood of an advertisement being viewed uncropped.

FIGS. 10A and 10B depict an example of an adjustment of supplemental content 1005 on content platform 1000 to supplemental content 1015. Content platform 1000 further comprises of main content 1010 and 1020 content sharing application Supplemental contents 1005 and 1015 may comprise of dynamic animations 1025 and 1035 that change based on a scrolling characteristic. In some embodiments, a dynamic animation 1025 is presented in supplemental content 1005 that uses input features to update its animation parameters. Animated characters such as 1025 and 1035 are rigged with anchor points that are connected to each other with varying strength and rigidity to simulate different features. For example, each anchor point, in addition to being connected to other anchor points, has its own position and rotation variable that may be adjusted to alter the display of the animation. The system can receive user input to animate and adjust the anchor points manually. In other embodiments, the system can dynamically adjust the anchor points in response to triggers, or a combination of inputs and manual insertion. For example, when a character jumps, the system can receive user input from an animator to manually create a jump launch animation that propels them into the air and then rely on dynamic forces such as walls and gravity to adjust the anchors mid-flight and reach out their arms to nearby ledges, resulting in a more natural and dynamic animation.

Inputs such as distance to screen edges and scroll speed and/or acceleration can be captured live and fed to a dynamic animation system configured to respond to such inputs. In FIGS. 10A and 10B, Mario 1035 would respond to the proximity of the screen ceiling by gradually crouching to make full use of his remaining space. If sufficient space is restored, Mario may wipe his brow and breathe a sigh of relief. The animated character may, for example, perform an action such as throwing an object and having the object bounce back. Also, for example, an animated character may reach down from a top of the screen and wave, and if a user, via the device, scrolls back up, the animated character may seamlessly transition to a different animation.

FIG. 11 depicts an example of supplemental content, labeled as 1115 and 1120, on an upper portion 1105 of a content sharing application interface 1100. The supplemental media includes a dynamic animation, labeled as 1115, that changes based on an orientation characteristic. A lower portion 1110 of the screen contains a conventional social media post.

In one embodiment, sensors in the device capture the device's orientation and feed those parameters to the dynamic animation. As shown in FIG. 11, the character Mario, labeled as 1115, scrambles to maintain his footing and begins sliding down the slope created by the device's orientation. The system may animate the dynamic animation to represent the character falling, climbing, or flying in response to any device orientation.

FIG. 12 depicts an example of supplemental content, labeled as 1215 and 1220, on an upper portion 1205 of a content sharing application interface 1200. The supplemental content includes a dynamic animation, labeled as 1215, that changes based on environmental metadata, in accordance with some embodiments of the disclosure. A lower portion 1210 of the screen contains a conventional social media post.

In one embodiment, environmental features such as weather or light level are used as inputs to a dynamic character animation to make it more responsive. Such inputs may be captured directly via the device or fed to the device from external sensors.

As shown in FIG. 12, the dynamic animated character, labeled as 1215, puts on sunglasses in response to detecting sunlight via device sensors or weather predictions of sunny weather, and an appropriate message 1220 is generated (e.g., a speech bubble for the character depicted at 1215).

FIG. 13 depicts an example of supplemental content 1305 on a content sharing application interface 1300, wherein the supplemental content includes a dynamic animation 1315 with speech bubble 1320 that change based on a scrolling characteristic removing the supplemental content from the viewport, in accordance with some embodiments of the disclosure.

In one embodiment, supplemental content is presented before or after the presentation of the primary content. For example, after a user has scrolled past an advertisement with an animated character, a speech bubble 1320 from that character may be presented poking down from the top of the screen. The animated character 1315 may have unique responses after the user, via the device, has seen a supplemental advertisement and returned to the original advertisement. For example, in FIG. 13, a supplemental content shows Mario's hand (e.g., at 1315) poking in from the top of the screen after being scrolled past. If the user, via the device, scrolled back up to the original content, Mario could react by saying “Good to see you again!” or “I am glad you came back!” In other embodiments, the supplemental content may be adjusted to be displayed as a transparent overlay on top of the main content in the feed. The transparent overlay of the supplemental content may be displayed in a particular location of the screen for a short duration. In some embodiments, the transparent overlay of the supplemental content is a display of adjusted animated character 1315.

In another example, the scrolling speed and the portion of the advertisement that was played due to the implementation of the advertisement-content modification method described in this document are reported by the publisher to the sell side platform when counting for impressions. This allows partial impressions to be accounted for when no impression is counted in the current implementation of impression reporting systems.

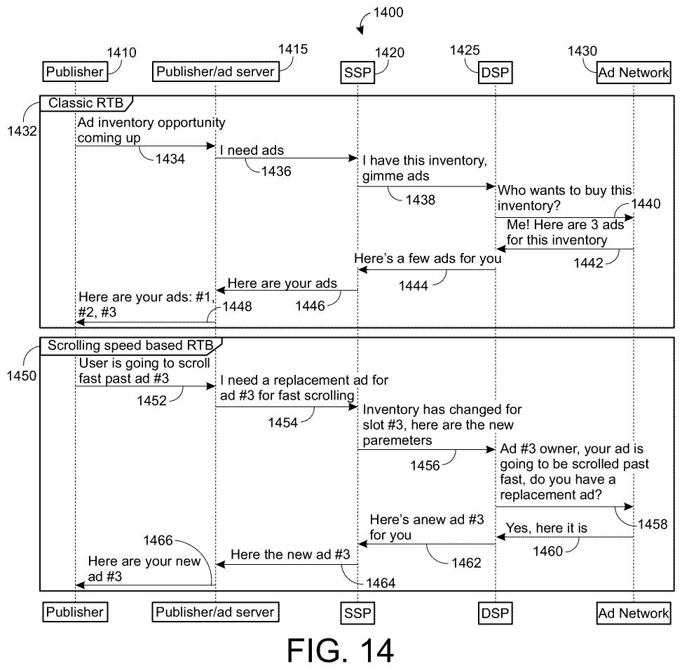

Similarly, if a publisher platform such as a social media platform detects that a user is going to be scrolling past a video advertisement at a speed that does not allow the content of the video advertisement to be played in its entirety, it may inform a supply side platform of that situation. Upon reception of such notification, the supply side platform may then qualify the advertisement-inventory as “fast scrolling” allowing the demand side platform to adjust the type of advertisement it bids for that inventory. FIG. 14 illustrates the possible exchange.

For example, an advertiser may create an advertisement for bidding on an ad exchange. The advertiser may set a maximum price to pay for an advertising slot, such as a maximum cost-per-impression limit or other criteria set by the advertisers. In some embodiments, the advertiser may also include in the bidding information sent to the DSP and ad-exchange information related to the target audience that the advertiser intends to publish the advertisement for. In other embodiments, the advertiser may filter inventory from SSPs that are on the ad-exchange for suitable inventory that matches the advertiser's criteria for the advertisement, and vice-versa.

FIG. 14 depicts an example process for retrieving supplemental content through a real-time bidding process.

The system may receive supplemental content from outside sources such as from a content delivery network, a content server, an ad network, an ad exchange, a social media platform, or another type of content platform. In some embodiments, the supplemental content is promoted content, such as an advertisement, which is promoted by a profile on the content sharing application (e.g., social media platform) that has a spending account with the content sharing application. For example, a profile of a pharmaceutical products company may have a marketing or advertising account with a social media platform in order to pay for pharmaceutical advertisements to be shown on the social media platform. System 1400 shows an illustrative diagram of processes to receive supplemental content such as advertisements from a source, such as an advertiser, outside of the content sharing application, such as a social media platform. Process 1432 describes of receiving supplemental content from a classic real-time-bidding (RTB) programmatic advertising method. Process 1450 describes of receiving supplemental content from using RTB, wherein the process comprises of bidding of advertisements based on the scrolling speed of a user through the social media feed. At 1434, publisher and/or content sharing application 1410 (e.g., social media platform) sends a request to ad server 1415 for an advertisement. In some embodiments, ad server 1415 is part of content sharing application 1410 and runs on the same network. In other embodiments, ad server 1415 may be a third-party ad server on a different network than the content sharing application.

At 1436, ad server 1415 sends a request to a supply side platform (SSP) 1420 to bid for an advertisement opportunity through an RTB network. In some embodiments, SSP 1420 may run on the same network as ad server 1415 and content sharing application 1410. In other embodiments, SSP 1420 may run on the same network as ad server 1415, but not on the same network as content sharing application 1410. In yet another embodiment, SSP 1420 may be on a different network than ad server 1415 and content sharing application 1410. In some embodiments, content sharing application 1410 sends a request for an advertisement directly to SSP 1410.

At 1438, DSP 1425 sends a bid request to SSP 1420 to find an inventory space on SSP 1420 to fill with an advertisement. In some embodiments, SSP 1420 and DSP 1425 are within the same “walled garden” advertising network 1430. In other embodiments advertising network 1430 connects SSP 1420 and DSP 1425. In some embodiments, RTB occurs on advertising network 1430. Advertising network 1430 determines that there is inventory to be filled on SSP 1420 at step 1440. At step 1442, advertising network 1430 receives advertisements from DSP 1425 to fill the empty inventory on SSP 1420 based on requirements for the empty inventory, e.g., DSP 1425 sends ads to SSP 1420 at 1444, SSP 1420 sends ads to publisher ad server 1415 at 1446, and publisher ad server 1415 sends ads to publisher 1410 at 1448.

In some embodiments, the requirements for the empty inventory may be included in the ad request sent from publisher and/or content sharing application 1410 to ad server 1415, from ad server 1415 to SSP 1420, or from SSP 1420 to ad network 1430. In some embodiments, the requirements for the empty inventory may include restrictions on advertisement size, genre, subject, demographic targeting, geographic targeting, age targeting, device compatibility, medium of advertisement (e.g., image, video, DOOH, AR/VR, etc.), or other targeting and compatibility requirements (e.g., other standardized guidelines as dictated by the Interactive Advertising Bureau (IAB)).

Such as in process 1450, requirements for the empty inventory may include scrolling data such as scrolling speed. At 1452, publisher and/or content sharing application 1410 sends an ad request to ad server 1415 with the scrolling data. Step 1452 in process 1450 corresponds to step 1434 in process 1432. Likewise, steps 1454, 1456, 1458, 1460, 1462, 1464, and 1466 correspond to steps 1436, 1438, 1440, 1442, 1444, 1446, and 1448, respectively.

In some embodiments, supplemental content is selectively controlled in a screen buffer. For example, if a portion or an entirety of supplemental content is skipped or scrolled past at a relatively fast pace (referred to herein as “fast scrolling” or the like), the supplemental content is retained in a designated content insertion slot as the screen buffer is repopulated and/or refreshed with primary content taken from a feed buffer. Also, for example, skipped supplemental content may be stored and/or inserted into a subsequent content feed slot (e.g., the skipped supplemental content is not automatically inserted in the next buffered content). Further, for example, skipped supplemental content is targeted to specific scenarios, e.g., inserted in sequence with other relevant primary content. Illustratively, if a user, via a user device, skips or fast scrolls through a car ad that was inserted after an article or post about automobile manufacturer supply chain issues (e.g., or other related subject matter), the car ad is stored and inserted after or around a later content item directed to similarly related subject matter.

In such examples, no additional request to a content server (e.g., ad server) is needed or transmitted, which provides a benefit of avoiding errors and/or spam filters caused by repeat requests to the content server, and helps to avoid miscounting of impressions. Also, for example, where the ad was fast scrolled past, the ad may be modified, e.g., modifying an arrangement and/or layout, a color scheme, or the like of the supplemental content to reduce a likelihood of a user recognizing the later presented ad as the same previously skipped ad. Such modifications to the supplemental content would not require an additional request to the ad server.

In an embodiment, modification of the supplemental content includes modifying a type of the content. In an example, supplemental content in a feed buffer is analyzed, and based on one or more scrolling characteristics and a screen buffer, a type of the content is selectively changed for subsequent insertion into the content feed. For example, where the supplemental content is initially a video, which is fast scrolled past, a different content type or version of the supplemental content is stored in the feed buffer (e.g., one or more images (e.g., in GIF format)) instead of the original video of the skipped supplemental content.

Further, one or more parameters associated with the supplemental content may be stored and/or communicated (e.g., to an ad server). Example parameters or data associated with the supplemental content relate to requesting and loading of the supplemental content to a post or feed buffer, the loading or transferring of the supplemental content to a screen buffer, and associated metadata (e.g., what portion(s) of the content reside in the screen buffer and for how long). Techniques for accurately counting and quantifying ad views or impressions are important, and rules for counting an impression can vary, e.g., an impression may be counted if at least one of the following conditions is detected: an ad is requested and provided, an ad or a threshold portion of the ad is displayed, some portion (e.g., 50%) of a video is played, combinations of the same, or the like. Storing and communication such data helps to accurately count impressions and for auditing purposes.

FIGS. 15A and 15B illustrate an example scenario 1500 of displaying supplemental content 1515 on a content sharing application using an AR/VR device, e.g., mobile device 1505 and/or an AR/VR headset 1510. For example, in the virtual environment seen via the AR/VR headset 1510, supplemental content 1515 from the content feed may hover above a surface of the mobile device 1505. Also, for example, an AR effect is provided to a side of a display. Further, for example, the supplemental content 1505 is transparent and/or viewable in pass-through. In another alternative embodiment, if a scrolling speed is detected to be too high to render the entirety of a video advertisement or other video content, a media platform may defer the playback of such video content to a connected Augmented Reality (AR) device. FIGS. 15A and 15B illustrate this concept, where video advertisements that have been scrolled past are stacked up as virtual objects in the user's augmented reality field of view, via the device.

In another embodiment, the system supports not only scrolling up and down, but also swiping left and right to generate more content feed. The same implementation of screen boundaries and squeezing multimedia elements (e.g., including animation) towards the screen edge and/or border to provide a last gap exposure before the swipe operation is complete is used for embodiments with left and right swipes. In further embodiments, for devices that use depth-based rendering such as AR/VR headsets, supplemental content that contains video that will end up with insufficient exposure will be provided extra exposure through the depth dimension.

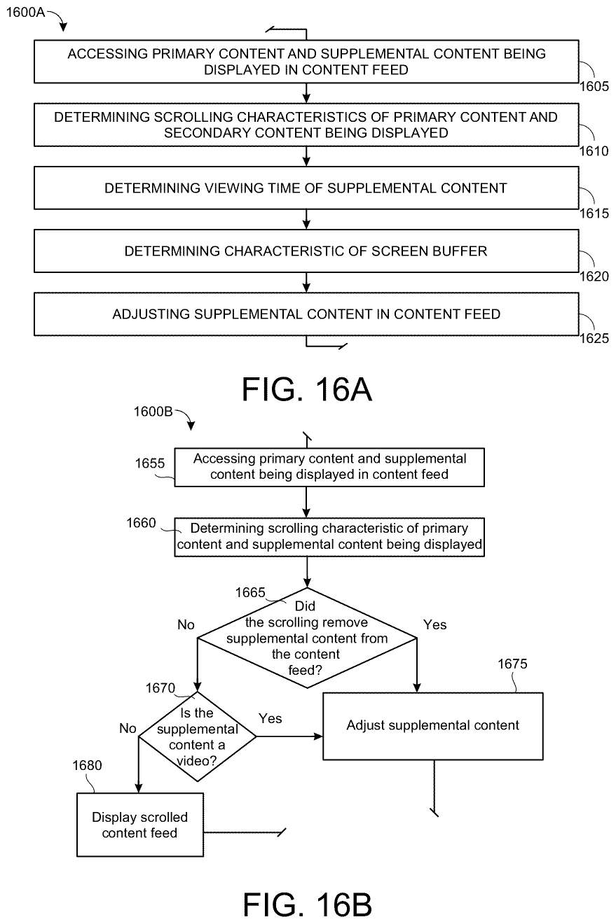

FIG. 16A shows an illustrative process 1600A for adjusting supplemental content in a content feed based on scrolling characteristics and a characteristic of a screen buffer, in accordance with some embodiments of the disclosure. For example, the process 1600A includes accessing 1605 primary content and supplemental content being displayed in a content feed. Also, for example, the process 1600A includes determining a scrolling characteristics of the primary content and the supplemental content being displayed. Further, for example, the scrolling characteristics include at least one of a speed of scrolling, an acceleration rate of the scrolling, a direction of the scrolling, a viewing time of the supplemental content, combinations of the same, or the like. In addition, for example, the process 1600A includes determining 1615 a viewing time of the supplemental content. Moreover, for example, the process 1600A includes determining 1620 a characteristic of a screen buffer. Furthermore, the process 1600A includes based at least in part on the scrolling characteristics of the primary content and the supplemental content being displayed and the characteristic of the screen buffer, adjusting 1625 the supplemental content in the content feed.

FIG. 16B illustrates process 1600B for adjusting supplemental content in a content feed based on a scrolling characteristic, in accordance with some embodiments of the disclosure. At 1655, the system accesses primary content, such as social media posts, displayed in a content feed, such as a social media feed. At 1660, the system determines a scrolling characteristic (e.g., scrolling speed) of the primary content being displayed. At 1665, based on the scrolling characteristic, the system determines if supplemental content (e.g., an advertisement) should be configured for extra exposure in the content feed. In some embodiments, the system determines that if the supplemental content should be configured for extra exposure based on whether the supplemental content was removed from the content feed. At 1675, in response to determining that the supplemental content has been removed from the content feed, the system adjusts the supplemental content to receive extra exposure. In some embodiments, the supplemental content was not removed from the content feed. At 1670, the system may determine if the supplemental content contains video. If the supplemental contains video, the system may adjust the video at 1675. In some embodiments, the system may adjust the video to play at a faster speed. At 1680, the system may determine, for example, that no adjustment is necessary for the supplemental content and the system may display the scrolled content feed as normal.

### Predictive Model

Throughout the present disclosure, in some embodiments, determinations, predictions, likelihoods, and the like are determined with one or more predictive models. In some embodiments, the model receives various forms of data about users, applications, media content items, devices, and more. This includes usage data, load-balancing data, and metadata. The model performs analysis based on hard rules, learning rules, hard models, learning models, usage data, load data, analytics, metadata, profile information, or combinations of these. The model outputs predictions of a future state of any of the devices described. Load-increasing events are determined by load-balancing processes. The model is based on inputs including hard rules, user-defined rules, rules defined by content providers, hard models, learning models, or combinations of these. The model is trained with data using various data processes, analytical processes, and machine learning approaches. It includes regression and classification analyses. An example of a multi-layer neural network is provided. The model is based on data engineering and modeling processes, and is operationalized using registration, deployment, monitoring, and retraining processes. The model is configured to output results to one or multiple devices, which can perform various functions. The devices can be a server, tablet, media display device, network-connected computer, media device, computing device, or combinations of these. The model outputs a current state, future state, determination, prediction, or likelihood. These outputs may be compared to a predetermined or determined standard. If the standard is satisfied or rejected, the predictive process outputs at least one of the current state, future state, determination, prediction, or likelihood to any device or module disclosed.

In some embodiments, the model ingests diverse forms of data about users, applications, media content items, devices, and more. This encompasses user interaction data, load-distribution data, and metadata. The model conducts analysis based on deterministic rules, learned rules, deterministic models, learned models, user interaction data, load data, analytics, metadata, user profile information, or combinations thereof. The model generates predictions of a future state of any of the described devices. Load-increasing events are identified by load-distribution processes.

The model is constructed based on inputs including deterministic rules, user-defined rules, rules defined by content providers, deterministic models, learned models, or combinations thereof. The model is trained with data using various data processing methods, analytical processes, and machine learning techniques. It includes regression and classification analyses. An example of a deep neural network is provided.

The model is built upon data engineering and modeling processes and is operationalized using registration, deployment, monitoring, and retraining processes. The model is designed to output results to one or multiple devices, which can perform various functions. The devices can be a server, tablet, digital display device, network-connected computer, media device, computing device, or combinations thereof.

The model outputs a current state, future state, determination, prediction, or probability. These outputs may be compared to a predetermined or determined benchmark. If the benchmark is met or not met, the predictive process outputs at least one of the current state, future state, determination, prediction, or probability to any device or module disclosed.

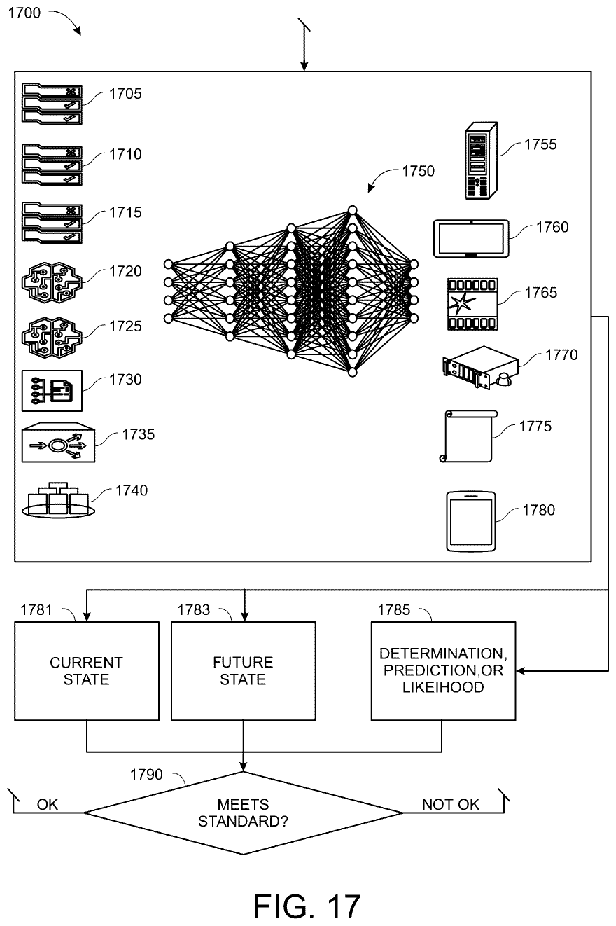

For example, FIG. 17 depicts a predictive model. A prediction process 1700 includes a predictive model 1750 in some embodiments. The predictive model 1750 receives as input various forms of data about one, more or all the users, applications, media content items, devices, and data described in the present disclosure. The predictive model 1750 performs analysis based on at least one of hard rules, learning rules, hard models, learning models, usage data, load data, analytics of the same, metadata, profile information, combinations of the same, or the like. The predictive model 1750 outputs one or more predictions of a future state of any of the devices described in the present disclosure. A load-increasing event is determined by load-balancing processes, e.g., least connection, least bandwidth, round robin, server response time, weighted versions of the same, resource-based processes, and address hashing. The predictive model 1750 is based on input including at least one of a hard rule 1705, a user-defined rule 1710, a rule defined by a content provider 1715, a hard model 1720, a learning model 1725, combinations of the same, or the like.

The predictive model 1750 receives as input usage data 1730. The predictive model 1750 is based, in some embodiments, on at least one of a usage pattern of the user or media device, a usage pattern of the requesting media device, a usage pattern of the media content item, a usage pattern of the communication system or network, a usage pattern of the profile, a usage pattern of the media device, combinations of the same, or the like.

The predictive model 1750 receives as input load-balancing data 1735. The predictive model 1750 is based on at least one of load data of the display device, load data of the requesting media device, load data of the media content item, load data of the communication system or network, load data of the profile, load data of the media device, combinations of the same, or the like.

The predictive model 1750 receives as input metadata 1740. The predictive model 1750 is based on at least one of metadata of the streaming service, metadata of the requesting media device, metadata of the media content item, metadata of the communication system or network, metadata of the profile, metadata of the media device, combinations of the same, or the like. The metadata includes information of the type represented in the media device manifest.

The predictive model 1750 is trained with data. The training data is developed in some embodiments using one or more data processes including but not limited to data selection, data sourcing, and data synthesis. The predictive model 1750 is trained in some embodiments with one or more analytical processes including but not limited to classification and regression trees (CART), discrete choice models, linear regression models, logistic regression, logit versus probit, multinomial logistic regression, multivariate adaptive regression splines, probit regression, regression processes, survival or duration analysis, and time series models. The predictive model 1750 is trained in some embodiments with one or more machine learning approaches including but not limited to supervised learning, unsupervised learning, semi-supervised learning, reinforcement learning, and dimensionality reduction. The predictive model 1750 in some embodiments includes regression analysis including analysis of variance (ANOVA), linear regression, logistic regression, ridge regression, and/or time series. The predictive model 1750 in some embodiments includes classification analysis including decision trees and/or neural networks. In FIG. 17, a depiction of a multi-layer neural network is provided as a non-limiting example of a predictive model 1750, the neural network including an input layer (left side), three hidden layers (middle), and an output layer (right side) with 32 neurons and 192 edges, which is intended to be illustrative, not limiting. The predictive model 1750 is based on data engineering and/or modeling processes. The data engineering processes include exploration, cleaning, normalizing, feature engineering, and scaling. The modeling processes include model selection, training, evaluation, and tuning. The predictive model 1750 is operationalized using registration, deployment, monitoring, and/or retraining processes.

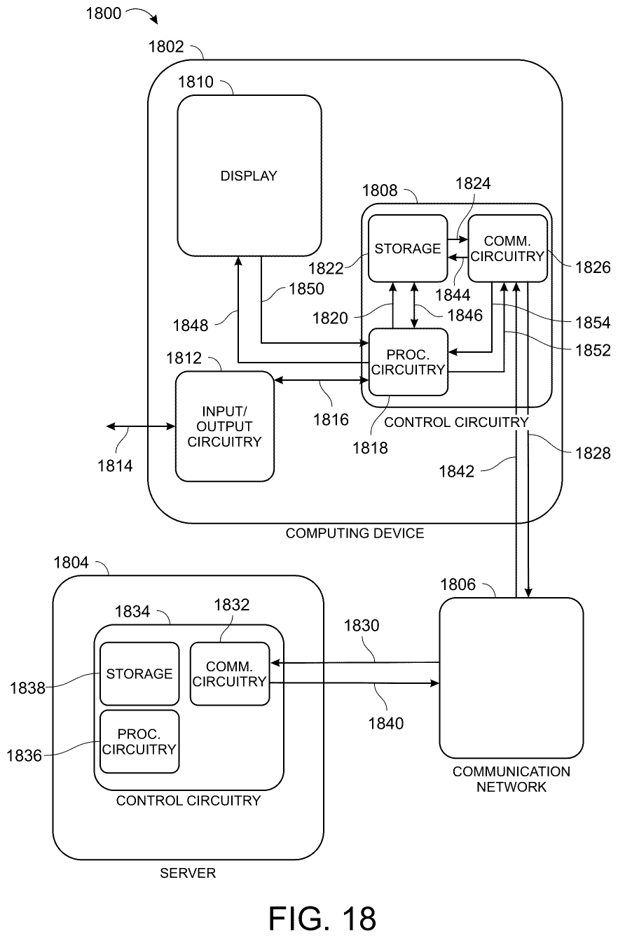

The predictive model 1740 is configured to output results to a device or multiple devices. The device includes means for performing one, more, or all the features referenced herein of the systems, methods, processes, and outputs of one or more of FIGS. 1-16 (above) and FIGS. 18-28 (below), in any suitable combination. The device is at least one of a server 1755, a tablet 1760, a media display device 1765, a network-connected computer 1770, a media device 1775, a computing device 1780, combinations of the same, or the like.

The predictive model 1750 is configured to output a current state 1781, and/or a future state 1783, and/or a determination, a prediction, or a likelihood 1785, and the like. The current state 1781, and/or the future state 1783, and/or the determination, the prediction, or the likelihood 1785, and the like may be compared 1790 to a predetermined or determined standard. In some embodiments, the standard is satisfied (1790=OK) or rejected (1790=NOT OK). If the standard is satisfied or rejected, the predictive process 1700 outputs at least one of the current state, the future state, the determination, the prediction, the likelihood to any device or module disclosed herein, combinations of the same, or the like. In some embodiments, the predictive model 1750 incorporates one or more large language models (LLMs).

For example, the predictive model 1750, as depicted in FIG. 17, is an artificial intelligence (AI) system that applies one or more features of the disclosed methods and systems. Also, for example, the model 1750 receives various forms of data about users, applications, media content items, devices, and other data described herein. This includes usage data 1730, load-balancing data 1735, and metadata 1740. The usage data could be related to the scrolling characteristics of the primary content, the size of the screen buffer, and the type of content being displayed. The load-balancing data could be related to the load data of the display device, the requesting media device, the media content item, the communication system or network, the profile, and the media device. The metadata could include information about the streaming service, the requesting media device, the media content item, the communication system or network, the profile, and the media device.

Further, for example, the predictive model 1750 performs analysis based on hard rules, learning rules, hard models, learning models, usage data, load data, analytics of the same, metadata, profile information, or combinations of the same. The model is trained with data using data processes including data selection, data sourcing, and data synthesis. The training involves analytical processes including classification and regression trees (CART), discrete choice models, linear regression models, logistic regression, logit versus probit, multinomial logistic regression, multivariate adaptive regression splines, probit regression, regression processes, survival or duration analysis, and time series models. The model is also trained with machine learning approaches including supervised learning, unsupervised learning, semi-supervised learning, reinforcement learning, and dimensionality reduction. The model is based on data engineering and modeling processes, which include exploration, cleaning, normalizing, feature engineering, scaling, model selection, training, evaluation, tuning, registration, deployment, monitoring, and retraining processes.

In addition, for example, the predictive model 1750 outputs one or more predictions of a future state of any of the devices described herein. This could include the current state 1781, the future state 1783, a determination, a prediction, or a likelihood 1785. These outputs may be compared 1790 to a predetermined or determined standard. If the standard is satisfied or rejected, the predictive process 1700 outputs at least one of the current state, the future state, the determination, the prediction, the likelihood to any device or module disclosed herein.

### Communication System

A communication system is provided including a computing device, a server, and a communication network. Both the server and the communication network can exist in multiple forms and can connect directly or indirectly. The computing device includes control circuitry, a display, and I/O circuitry. The control circuitry can execute systems, methods, processes, and outputs. Both the computing device and server include control circuitry and storage, which can store content, metadata, data, user profiles, messages, and commands for an application. The computing device communicates with an I/O device and can receive and process user inputs locally or transmit them to the remote server for processing. Both the server and the computing device can transmit and receive content via the communication network or directly, and the processing circuitry receives the user input and converts it to digital signals.

In some embodiments, the system is a distributed network with an edge device (a type of computing device 1802), a cloud server (a type of server 1804), and an internet of things (IoT) network (a type of communication network 1806). Both the edge device and server have microservices and data lakes. The edge device includes a user interface and I/O ports. User interactions can be processed at the edge or in the cloud. The system can transmit and receive digital assets via the IoT network. The edge device communicates with an IoT device and can be various types of smart devices capable of displaying and interacting with digital content. The communication paths in the system can be optimized for latency and bandwidth efficiency.

FIG. 18 depicts a block diagram of system 1800, in accordance with some embodiments. The system is shown to include computing device 1802, server 1804, and a communication network 1806. It is understood that while a single instance of a component may be shown and described relative to FIG. 18, additional embodiments of the component may be employed. For example, server 1804 may include, or may be incorporated in, more than one server. Similarly, communication network 1806 may include, or may be incorporated in, more than one communication network. Server 1804 is shown communicatively coupled to computing device 1802 through communication network 1806. While not shown in FIG. 18, server 1804 may be directly communicatively coupled to computing device 1802, for example, in a system absent or bypassing communication network 1806.

Communication network 1806 may include one or more network systems, such as, without limitation, the Internet, LAN, Wi-Fi, wireless, or other network systems suitable for audio processing applications. The system 1800 of FIG. 18 excludes server 1804, and functionality that would otherwise be implemented by server 1804 is instead implemented by other components of the system depicted by FIG. 18, such as one or more components of communication network 1806. In still other embodiments, server 1804 works in conjunction with one or more components of communication network 1806 to implement certain functionality described herein in a distributed or cooperative manner. Similarly, the system depicted by FIG. 18 excludes computing device 1802, and functionality that would otherwise be implemented by computing device 1802 is instead implemented by other components of the system depicted by FIG. 18, such as one or more components of communication network 1806 or server 1804 or a combination of the same. In other embodiments, computing device 1802 works in conjunction with one or more components of communication network 1806 or server 1804 to implement certain functionality described herein in a distributed or cooperative manner.

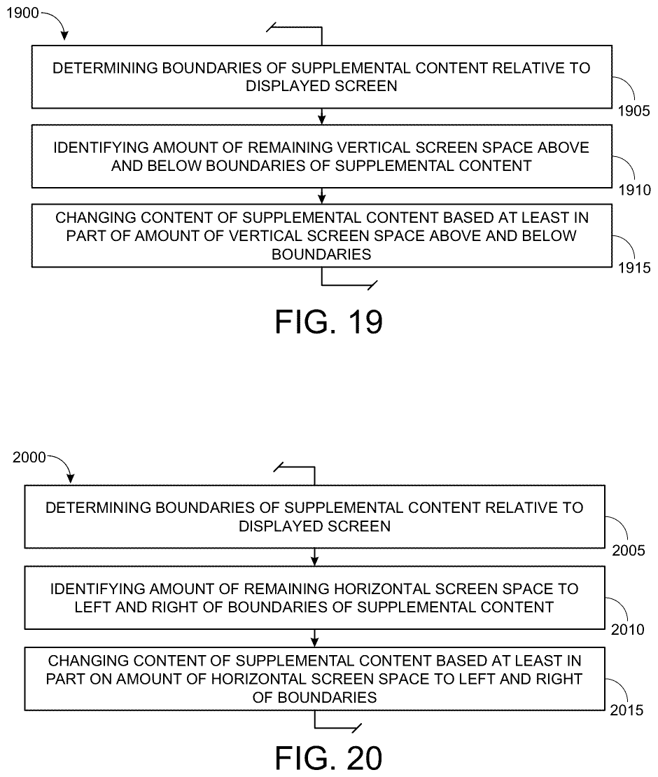

Computing device 1802 includes control circuitry 1808, display 1810 and input/output (I/O) circuitry 1812. Control circuitry 1808 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), application-specific integrated circuits (ASICs), system-on-chip (SoC), application-specific standard parts (ASSPs), indium phosphide (InP)-based monolithic integration and silicon photonics, non-classical devices, organic semiconductors, compound semiconductors, “More Moore” devices, “More than Moore” devices, cloud-computing devices, combinations of the same, or the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i7 processor and an Intel Core i9 processor). Some control circuits may be implemented in hardware, firmware, or software. Control circuitry 1808 in turn includes communication circuitry 1826, storage 1822 and processing circuitry 1818. Either of control circuitry 1808 and 1834 may be utilized to execute or perform any or all the systems, methods, processes, and outputs of one or more of FIGS. 1-17 (above) and FIGS. 19-28 (below), or any combination of steps thereof (e.g., as enabled by processing circuitries 1818 and 1836, respectively).

In addition to control circuitry 1808 and 1834, computing device 1802 and server 1804 may each include storage (storage 1822, and storage 1838, respectively). Each of storages 1822 and 1838 may be an electronic storage device. As referred to herein, the phrase “electronic storage device” or “storage device” should be understood to mean any device for storing electronic data, computer software, or firmware, such as random-access memory, read-only memory, cloud-based storage, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 1822 and 1838 may be used to store several types of content, metadata, and/or other types of data. Non-volatile memory may also be used (e.g., to launch a boot-up routine and other instructions). Cloud-based storage may be used to supplement storages 1822 and 1838 or instead of storages 1822 and 1838. In some embodiments, a user profile and messages corresponding to a chain of communication may be stored in one or more of storages 1822 and 1838. Each of storages 1822 and 1838 may be utilized to store commands, for example, such that when each of processing circuitries 1818 and 1836, respectively, are prompted through control circuitries 1808 and 1834, respectively. Either of processing circuitries 1818 or 1836 may execute any of the systems, methods, processes, and outputs of one or more of FIGS. 1-17 (above) and FIGS. 19-28 (below), or any combination of steps thereof.

In some embodiments, control circuitry 1808 and/or 1834 executes instructions for an application stored in memory (e.g., storage 1822 and/or storage 1838). Specifically, control circuitry 1808 and/or 1834 may be instructed by the application to perform the functions discussed herein. In some embodiments, any action performed by control circuitry 1808 and/or 1834 may be based on instructions received from the application. For example, the application may be implemented as software or a set of and/or one or more executable instructions that may be stored in storage 1822 and/or 1838 and executed by control circuitry 1808 and/or 1834. The application may be a client/server application where only a client application resides on computing device 1802, and a server application resides on server 1804.

The application may be implemented using any suitable arrangement. For example, it may be a stand-alone application wholly implemented on computing device 1802. In such an approach, instructions for the application are stored locally (e.g., in storage 1822), and data for use by the application is downloaded on a periodic basis (e.g., from an out-of-band feed, from an Internet resource, or using another suitable approach). Control circuitry 1808 may retrieve instructions for the application from storage 1822 and process the instructions to perform the functionality described herein. Based on the processed instructions, control circuitry 1808 may determine a type of action to perform based at least in part on input received from I/O circuitry 1812 or from communication network 1806.

The computing device 1802 is configured to communicate with an I/O device (not shown) via the I/O circuitry 1812. In some embodiments, the user input 1814 is received from the I/O device. A wired and/or wireless connection between the I/O circuitry 1812 and the I/O device is provided in some embodiments. The I/O device may be, for example, at least one of a keyboard, a mouse, a touchscreen, a microphone, a scanner, a joystick, a graphics tablet, a monitor, a printer, speakers, headphones, a projector, a headset, a wearable device, a gaming controller, an external hard drive, a USB hard drive, an SD card, a network interface card (NIC), combinations of the same, or the like.

In client/server-based embodiments, control circuitry 1808 may include communication circuitry suitable for communicating with an application server (e.g., server 1804) or other networks or servers. The instructions for conducting the functionality described herein may be stored on the application server. Communication circuitry may include a cable modem, an Ethernet card, or a wireless modem for communication with other equipment, or any other suitable communication circuitry. Such communication may include the Internet or any other suitable communication networks or paths (e.g., communication network 1806). In another example of a client/server-based application, control circuitry 1808 runs a web browser that interprets web pages provided by a remote server (e.g., server 1804). For example, the remote server may store the instructions for the application in a storage device.

The remote server may process the stored instructions using circuitry (e.g., control circuitry 1834) and/or generate displays. Computing device 1802 may receive the displays generated by the remote server and may display the content of the displays locally via display 1810. For example, display 1810 may be utilized to present a string of characters. This way, the processing of the instructions is performed remotely (e.g., by server 1804) while the resulting displays, such as the display windows described elsewhere herein, are provided locally on computing device 1804. Computing device 1802 may receive inputs from the user via input/output circuitry 1812 and transmit those inputs to the remote server for processing and generating the corresponding displays.

Alternatively, computing device 1802 may receive inputs from the user via input/output circuitry 1812 and process and display the received inputs locally, by control circuitry 1808 and display 1810, respectively. For example, input/output circuitry 1812 may correspond to a keyboard and/or a set of and/or one or more speakers/microphones which are used to receive user inputs (e.g., input as displayed in a search bar or a display of FIG. 18 on a computing device). Input/output circuitry 1812 may also correspond to a communication link between display 1810 and control circuitry 1808 such that display 1810 updates based at least in part on inputs received via input/output circuitry 1812 (e.g., simultaneously update what is shown in display 1810 based on inputs received by generating corresponding outputs based on instructions stored in memory via a non-transitory, computer-readable medium).

Server 1804 and computing device 1802 may transmit and receive content and data such as media content via communication network 1806. For example, server 1804 may be a media content provider, and computing device 1802 may be a smart television configured to download or stream media content, such as a live news broadcast, from server 1804. Control circuitry 1834, 1808 may send and receive commands, requests, and other suitable data through communication network 1806 using communication circuitry 1832, 1826, respectively. Alternatively, control circuitry 1834, 1808 may communicate directly with each other using communication circuitry 1832, 1826, respectively, avoiding communication network 1806.

It is understood that computing device 1802 is not limited to the embodiments and methods shown and described herein. In nonlimiting examples, computing device 1802 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 1802 receives user input 1814 at input/output circuitry 1812. For example, computing device 1802 may receive a user input such as a user swipe or user touch. It is understood that computing device 1802 is not limited to the embodiments and methods shown and described herein.

User input 1814 may be received from a user selection-capturing interface that is separate from device 1802, such as a remote-control device, trackpad, or any other suitable user movement-sensitive, audio-sensitive or capture devices, or as part of device 1802, such as a touchscreen of display 1810. Transmission of user input 1814 to computing device 1802 may be accomplished using a wired connection, such as an audio cable, USB cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, NearLink, ultra-wideband technology, or any other suitable wireless transmission protocol. Input/output circuitry 1812 may include a physical input port such as a 12.5 mm (0.4921 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, NearLink, ultra-wideband technology, or other wireless transmission protocols.

Processing circuitry 1818 may receive user input 1814 from input/output circuitry 1812 using communication path 1816. Processing circuitry 1818 may convert or translate the received user input 1814 that may be in the form of audio data, visual data, gestures, or movement to digital signals. In some embodiments, input/output circuitry 1812 performs the translation to digital signals. In some embodiments, processing circuitry 1818 (or processing circuitry 1836, as the case may be) conducts disclosed processes and methods.

Processing circuitry 1818 may provide requests to storage 1822 by communication path 1820. Storage 1822 may provide requested information to processing circuitry 1818 by communication path 1846. Storage 1822 may transfer a request for information to communication circuitry 1826 which may translate or encode the request for information to a format receivable by communication network 1806 before transferring the request for information by communication path 1828. Communication network 1806 may forward the translated or encoded request for information to communication circuitry 1832, by communication path 1830.

At communication circuitry 1832, the translated or encoded request for information, received through communication path 1830, is translated or decoded for processing circuitry 1836, which will provide a response to the request for information based on information available through control circuitry 1834 or storage 1838, or a combination thereof. The response to the request for information is then provided back to communication network 1806 by communication path 1840 in an encoded or translated format such that communication network 1806 forwards the encoded or translated response back to communication circuitry 1826 by communication path 1842.

At communication circuitry 1826, the encoded or translated response to the request for information may be provided directly back to processing circuitry 1818 by communication path 1854 or may be provided to storage 1822 through communication path 1844, which then provides the information to processing circuitry 1818 by communication path 1846. Processing circuitry 1818 may also provide a request for information directly to communication circuitry 1826 through communication path 1852, where storage 1822 responds to an information request (provided through communication path 1820 or 1844) by communication path 1824 or 1846 that storage 1822 does not contain information pertaining to the request from processing circuitry 1818.

Processing circuitry 1818 may process the response to the request received through communication paths 1846 or 1854 and may provide instructions to display 1810 for a notification to be provided to the users through communication path 1848. Display 1810 may incorporate a timer for providing the notification or may rely on inputs through input/output circuitry 1812 from the user, which are forwarded through processing circuitry 1818 through communication path 1848, to determine how long or in what format to provide the notification. When display 1810 determines the display has been completed, a notification may be provided to processing circuitry 1818 through communication path 1850.

The communication paths provided in FIG. 18 between computing device 1802, server 1804, communication network 1806, and all subcomponents depicted are examples and may be modified to reduce processing time or enhance processing capabilities for each step in the processes disclosed herein by one skilled in the art.

FIG. 19 illustrates process 1900 for changing supplemental content based on the amount of vertical screen space above and below the supplemental content, in accordance with some embodiments of the disclosure. At 1905, the system determines the boundaries of supplemental content (e.g., an advertisement or other social media post) relative to the device screen. At 1910, the system identifies the amount of vertical screen space above and below the boundaries of the supplemental content. For example, the system may identify that the top boundary of the supplemental content is about 2 inches (about 5.08 centimeters) from the top of the display screen of the device. In some embodiments, the amount of vertical screen space may be identified using pixels, centimeters, percentage of screen size, or other display measurement. In some embodiments, the boundaries of supplemental content may be determined by location data describing the location of the supplemental content in relation to the device screen. For example, the supplemental content may have location data indicating that the top left corner is at position (xx, yy). The supplemental content may also have size data that indicates a size of the supplemental content. At 1915, the system changes the supplemental content based at least in part of the amount of vertical screen space is left above or below the boundaries of the supplemental content. For example, the system may modify the playback speed of a video (e.g., in an advertisement or even that of primary content) if it is determined to be close to the top border of the device screen. In some embodiments, there is no vertical space above or below the boundaries of the supplemental content in a feed that scrolls vertically. In other embodiments, there is no horizontal space left or right of the boundaries of the supplemental content in a feed that scrolls horizontally. In these embodiments, the supplemental content is determined to be scrolling out of the feed and adjustments to the supplemental content is made to keep display of the content in the feed.

FIG. 20 illustrates process 2000 for changing supplemental content based on the amount of horizontal screen space to the left and right of the supplemental content, in accordance with some embodiments of the disclosure. At 2005, the system determines the boundaries of supplemental content (e.g., an advertisement or other social media post) relative to the device screen. At 2010, the system identifies the amount of horizontal screen space to the left and right of the boundaries of the supplemental content. For example, the system may identify that the left boundary of the supplemental content is about 2 inches (about 5.08 centimeters) from the left side of the display screen of the device. In some embodiments, the amount of horizontal screen space may be identified using pixels, centimeters, percentage of screen size, or other display measurement. In some embodiments, the boundaries of supplemental content may be determined by location data describing the location of the supplemental content in relation to the device screen. For example, the supplemental content may have location data indicating that the top left corner is at a coordinate position (e.g., xx, yy). The supplemental content may also have size data that indicates a size of the supplemental content. At 2015, the system changes the supplemental content based at least in part of the amount of horizontal screen space remains to the left and to the right of the boundaries of the supplemental content. For example, the system may modify the playback speed of a video in an advertisement if it is determined to be close to the left border of the device screen.

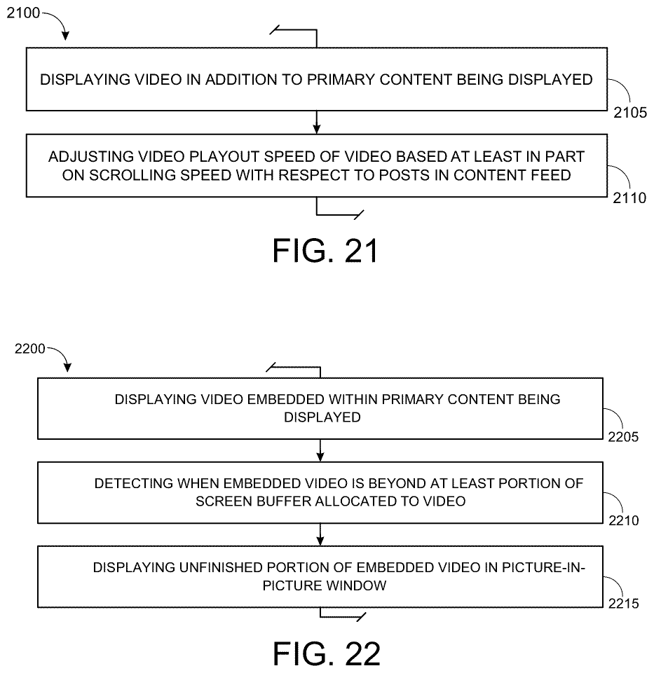

FIG. 21 shows an illustrative process 2100 for adjusting video playout speed based on an identified scrolling speed, in accordance with some embodiments of this disclosure. At 2105, the system may determine that there is video being displayed in a social media feed in addition to primary content, such as posts from user profiles, being displayed. In some embodiments, the system may determine that the user, via the device, is scrolling through the media feed at a scrolling speed. At 2110, the system may adjust the video playout speed based at least in part on the scrolling speed with respect to posts in the content feed. For example, the system may determine that a user is scrolling quickly through the media feed, but a video being displayed in the feed has not yet finished playing. The system may continue playing the rest of the video at 2× speed or faster based on how quickly the user, via the device, is scrolling through the feed.

FIG. 22 shows an illustrative process 2200 for displaying video in a PiP window after it has left the screen buffer, in accordance with some embodiments of this disclosure, and which may be provided in combination with one or more features of other embodiments disclosed herein. At 2205, the system may determine that there is video embedded within primary content being displayed in a social media feed. The displayed content and the video are within a screen buffer, wherein all items in the screen buffer are being displayed on a user device. At 2210, the system may determine that the video is no longer in the screen buffer. For example, the user, via the device, has scrolled the video off the display screen of a user device. The user device either removes the video from the screen buffer stored on the device or removes the video from the screen buffer being casted by a server. At 2215, the system displays the unfinished portion of the embedded video in a PiP window within the device display screen. In some embodiments, the unfinished portion of the video in the PiP window is no longer in the screen buffer. In some embodiments, the system identifies important features in the unfinished portion of the embedded video and displays the important features in a PiP window within the device display screen.

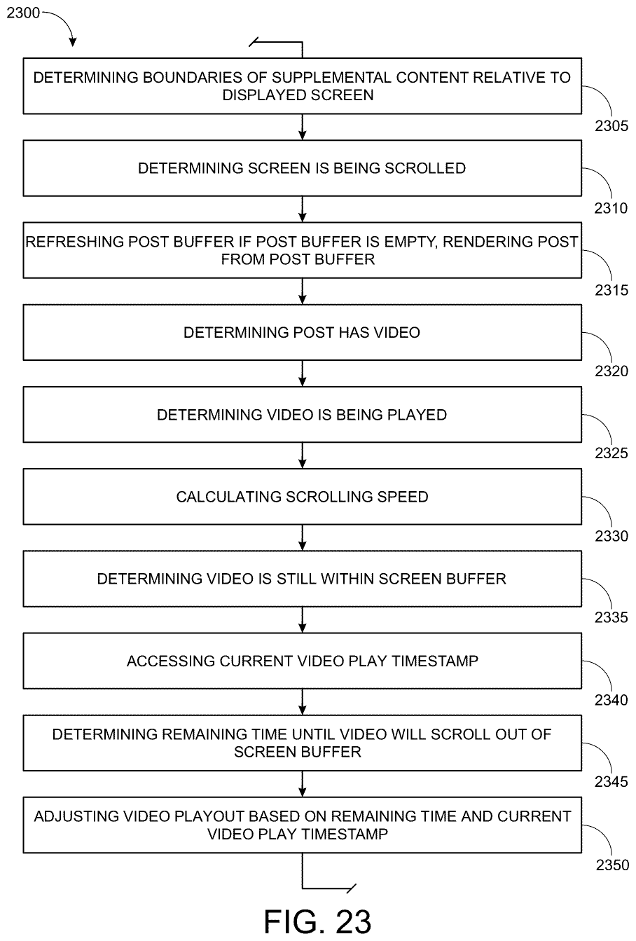

FIG. 23 shows an illustrative process 2300 for adjusting video playout based on remaining time left in the video before being scrolled out of the screen buffer, in accordance with some embodiments of this disclosure. At 2305, the system may determine boundaries of a promoted content, such as an advertisement, in relation to the boundaries of a display screen on which the promoted content is displayed on. At 2310, the system may determine that the screen is being scrolled or a time since a last interaction. In some embodiments, the system may determine that the screen is being scrolled or a time since a last interaction by receiving user interaction data with the user device of the display screen indicating that the user, via the device, is swiping on the screen. At 2315, the system may refresh the feed buffer if the feed buffer is empty and then render a post from the feed buffer for display. In some embodiments, the system may determine that the user, via the device, is scrolling through a screen. In addition to updating the screen buffer with the new posts from the feed buffer, the system may determine that the feed buffer is to be configured for a new load of posts from a content server. The system may send a request to the content server to retrieve a new load of posts to insert into the feed buffer. At 2320, the system may determine that a post from the feed buffer, now in the screen buffer and being displayed on the device screen, has video. At 2325, the system may determine that the video is being played. For example, the system may determine that a user has clicked play on the video and begun playback of the video. At 2330, the system may calculate a scrolling speed of a user scrolling input. At 2340, the system may access a current video play time stamp of the video at the time of the user, via the device, scrolling input. At 2340, the system may determine the remaining time until the video will scroll out of the screen buffer. In some embodiments, the system determines the remaining time until the video will scroll out of the screen buffer based on the scrolling speed of the user, via the device. At 2350, the system may adjust the video playout based on the remaining time and current video play timestamp. In some embodiments, the system may calculate a remaining time of the video based on the current video play time stamp at the time of the user scrolling input via the device. The system may determine that the user, via the device, is scrolling through the content feed at a scrolling speed and will adjust the video playout to match the scrolling speed. For example, the system may determine that the user, via the device, is scrolling through content at 20 content items per minute. The system may determine that the screen buffer only has space for 5 content items, therefore each content item will be viewed for an average of about 3 seconds, and will be on the screen for about 15 seconds before it will be shuffled out of the screen buffer. The system may determine that a video in the content feed has about 30 seconds left to play and has about 15 seconds left in the screen buffer. The system may speed up the playback of the video at 2× the original speed so that the entire video plays out before it is shuffled out of the screen buffer.

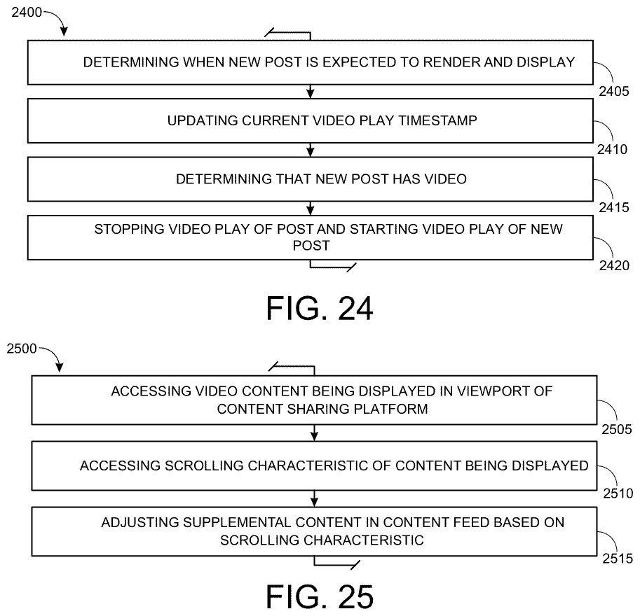

FIG. 24 shows an illustrative process 2400 for stopping video play of a post and starting video play of a new post, in accordance with some embodiments of this disclosure, and which may be provided in combination with one or more features of other embodiments disclosed herein (e.g., in combination with one or more features of embodiments in which content is altered based on scrolling characteristics). At 2405, the system may determine when a new post is expected to render and display. At 2410, the system may update current video play timestamp of a current video in the screen buffer. At 2415, the system may determine that the new post has video. At 2420, the system may stop video play of the current video and start video play of the new post.

FIG. 25 shows an illustrative process 2500 for adjusting supplemental content in content feed based on a scrolling characteristic, in accordance with some embodiments of this disclosure. At 2505, the system may access video content being displayed in a viewport of the content sharing application. In some embodiments, any content item displayed in the viewport of the content sharing application is in the screen buffer. At 2510, the system may access a scrolling characteristic of the content being displayed. At 2515, the system may adjust supplemental content in the content feed based on the scrolling characteristic.

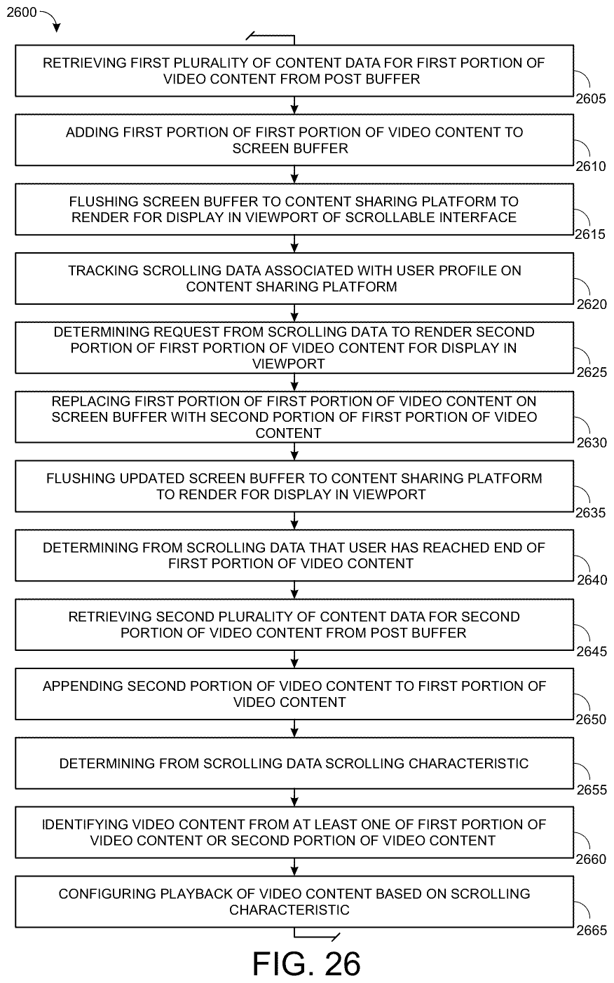

FIG. 26 shows an illustrative process 2600 for loading a complete video from a feed buffer into a screen buffer and adjusting the video based on a scrolling characteristic, in accordance with some embodiments of this disclosure. At 2605, the system may retrieve a first plurality of content data for a first portion of video content from a feed buffer. The content data may be video data to render the first portion of the video content. The content data may also comprise of video metadata describing the content of the video, specifications of the video, or other types of video metadata that may be transmitted along with a video file. At 2610, the system may add a first segment of the first portion of video content to a screen buffer. For example, the system may upload a segment of the first portion of video content to a screen buffer that will be sent to a user device, or in other embodiments, are stored on the user device. At 2615, the system may flush the screen buffer to a content sharing application to render for display in the viewport of a scrollable interface. At 2620, the system may track scrolling data associated with a user profile on the content sharing application. At 2625, the system may determine a request from the scrolling data to render a second segment of the first portion of the video content for display in the viewport. For example, the system may request for the second segment of the first portion of video content to be loaded onto the screen buffer. At 2630, the system may replace the first segment of the first portion of the video content on the screen buffer with the second segment of the first portion of the video content. At 2635, the system may flush the updated screen buffer to the content sharing application to render for display in the viewport. At 2640, the system may determine from the scrolling data that the user, via the device, has reached the end of the first portion of the video content. At 2645, the system may retrieve a second plurality of content data for a second portion of the video content from the feed buffer. At 2650, the system may append the second portion of the video content to the first portion of the video content. At 2655, the system may determine from the scrolling data a scrolling characteristic (e.g., a scrolling speed). At 2660, the system may identify a specific part of the video content from at least one of the first portion of the video content or the second portion of the video content. At 2665, the system may configure a playback of the specific part of the video content based on the scrolling characteristic.

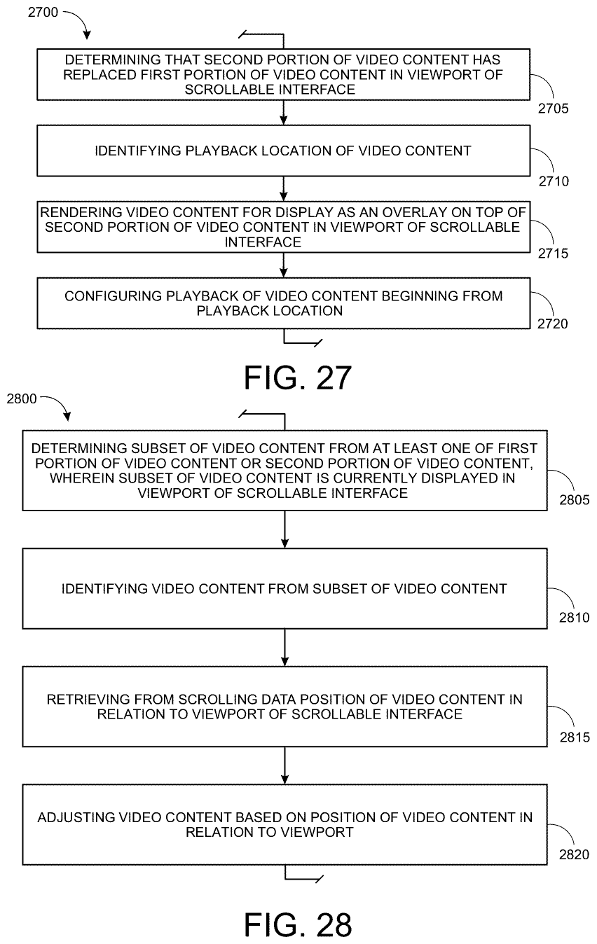

FIG. 27 shows an illustrative process 2700 for replacing a first portion of a video content with a second portion of the video content and rendering the video content for display as an overlay of the second portion of the video, in accordance with some embodiments of the disclosure. At 2705, the system may determine that the second portion of the video content has replaced the first portion of the video content in the viewport of the scrollable interface. At 2710, the system may identify a playback timestamp of the video content. At 2715, the system renders the video content for display as an overlay on top of the second portion of the video content in the viewport of the scrollable interface. At 2720, the system may configure the playback of the video content beginning from the playback timestamp.

FIG. 28 shows an illustrative process 2800 for adjusting video content based on the position of the video content in relation to a viewport, in accordance with some embodiments of the disclosure. At 2805, the system may determine a subset of the video content from at least one of the first portion of the video content or the second portion of the video content, wherein the subset of the video content is currently displayed in the viewport of the scrollable interface. At 2810, the system may identify the video content from the subset of the video content. At 2815, the system may retrieve from the scrolling data a position of the video content in relation to the viewport of the scrollable interface. At 2820, the system may adjust the video content based on the position of the video content in relation to the viewport.

### Terminology

The terminology used herein is for the purpose of describing particular embodiments only and is not intended to be limiting of the disclosure.

The terms “primary” and “secondary” (or “supplemental”) as used herein with respect to content are used for convenience and do not imply, e.g., a hierarchy or ordering of information. For example, in some embodiments, primary content is a social media feed and secondary content is an advertisement or additional content displayed along with the social media feed.

Throughout the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises.”Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

As used herein, the terms “real time,” “simultaneous,” “substantially on-demand,” and the like are understood to be nearly instantaneous but may include delay due to practical limits of the system. Such delays may be in the order of milliseconds or microseconds, depending on the application and nature of the processing. Relatively longer delays (e.g., greater than a millisecond) may result due to communication or processing delays, particularly in remote and cloud computing environments.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least some embodiments are described as using a plurality of units or modules to perform a process or processes, it is understood that the process or processes may also be performed by one or a plurality of units or modules. Additionally, it is understood that the term controller/control unit may refer to a hardware device that includes a memory and a processor. The memory may be configured to store the units or the modules, and the processor may be specifically configured to execute said units or modules to perform one or more processes which are described herein.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The use of the terms “first”, “second”, “third”, and so on, herein, are provided to identify structures or operations, without describing an order of structures or operations, and, to the extent the structures or operations are used in an embodiment, the structures may be provided or the operations may be executed in a different order from the stated order unless a specific order is definitely specified in the context.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random access memory (RAM), UltraRAM, cloud-based storage, and the like.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not infer that the feature is necessary. Inclusion of the phrase “in some embodiments” does not infer that the feature is not applicable to other embodiments or even all embodiments.

The systems and processes discussed herein are intended to be illustrative and not limiting. One skilled in the art would appreciate that the actions of the processes discussed herein may be omitted, modified, combined, duplicated, rearranged, and/or substituted, and any additional actions may be performed without departing from the scope of the invention. More generally, the disclosure herein is meant to provide examples and is not limiting. Only the claims that follow are meant to set bounds as to what the present disclosure includes. Furthermore, it should be noted that the features and limitations described in any some embodiments may be applied to any other embodiment herein, and flowcharts or examples relating to some embodiments may be combined with any other embodiment in a suitable manner, done in different orders, or done in parallel. In addition, the methods and systems described herein may be performed in real time. It should also be noted that the methods and/or systems described herein may be applied to, or used in accordance with, other methods and/or systems.

This description is to be taken only by way of example and not to otherwise limit the scope of the embodiments herein. Therefore, it is the object of the appended claims to cover all such variations and modifications as come within the true spirit and scope of the embodiments herein.

1. A method comprising:
accessing primary content and supplemental content being displayed in a content feed;
determining scrolling characteristics of the primary content and the supplemental content being displayed, wherein the scrolling characteristics include a speed of scrolling, an acceleration rate of the scrolling, and a direction of the scrolling;
determining a viewing time of the supplemental content;
determining a characteristic of a screen buffer; and
based at least in part on the scrolling characteristics of the primary content and the supplemental content being displayed, the viewing time, and the characteristic of the screen buffer, adjusting the supplemental content in the content feed.

2. The method of claim 1, wherein:
the screen buffer comprises the primary content and the supplemental content;
the characteristic of the screen buffer comprises a size of the screen buffer; and
the adjusting the supplemental content in the content feed is based at least in part on the scrolling characteristics of the primary content and the supplemental content being displayed, and the size of the screen buffer.

3. The method of claim 1, wherein the adjusting the supplemental content in the content feed comprises:
determining boundaries of the supplemental content relative to a display screen;
identifying an amount of vertical screen space above and below the boundaries of the supplemental content; and
based at least in part on the amount of vertical screen space above and below the boundaries of the supplemental content being below a threshold, changing content of the supplemental content.

4. The method of claim 1, wherein the adjusting the supplemental content in the content feed comprises:
determining boundaries of the supplemental content relative to a display screen;
identifying an amount of horizontal screen space to a left side of and to a right side of the boundaries of the supplemental content; and
based at least in part on the amount of horizontal screen space to the left side of and to the right side of the boundaries of the supplemental content being below a threshold, changing content of the supplemental content.

5. The method of claim 1, wherein the scrolling characteristics comprise at least one of a scroll depth, a bounce rate, a load time, a size of a feed buffer, a size of the screen buffer, a size of an available memory, an eye gaze characteristic, a touchscreen input, a scroll pattern, a user interaction via a user device, a scroll position, a time on a page, or an end-of-scroll indicator.

6. The method of claim 1, wherein the content feed includes a video, and wherein the adjusting the supplemental content in the content feed comprises:
adjusting a video playout speed of the video based at least in part on a scrolling speed with respect to content in the content feed.

7. The method of claim 1, wherein the adjusting the supplemental content in the content feed comprises:
displaying a video embedded within the primary content being displayed;
detecting when the video embedded within the primary content being displayed is beyond at least a portion of the screen buffer allocated to the video; and
based at least in part on detecting the video embedded within the primary content being displayed is beyond the at least the portion of the screen buffer allocated to the video, displaying a modified video based on an unfinished portion of the video in a picture-in-picture window.

8. The method of claim 7, wherein the displaying the unfinished portion of the video in the picture-in-picture window is played with an accelerated adjusted speed.

9. The method of claim 8, wherein the displaying the unfinished portion of the video in the picture-in-picture window is played with the accelerated adjusted speed until a next content with video appears in the content feed.

10. The method of claim 1, wherein the adjusting the supplemental content in the content feed comprises:
dynamically adjusting rendering of images contained in the content feed.

11-40. (canceled)

41. A system comprising:
circuitry configured to:
access primary content and supplemental content being displayed in a content feed;
determine scrolling characteristics of the primary content and the supplemental content being displayed, wherein the scrolling characteristics comprise a speed of scrolling, an acceleration rate of the scrolling, and a direction of the scrolling;
determine a viewing time of the supplemental content;
determine a characteristic of a screen buffer; and
based at least in part on the scrolling characteristics of the primary content and the supplemental content being displayed, the viewing time, and the characteristic of the screen buffer, adjust the supplemental content in the content feed.

42. The system of claim 41, wherein:
the screen buffer comprises the primary content and the supplemental content;
the characteristic of the screen buffer comprises a size of the screen buffer; and
the adjusting the supplemental content in the content feed is based at least in part on the scrolling characteristics of the primary content and the supplemental content being displayed and the size of the screen buffer.

43. The system of claim 41, wherein:
the adjusting the supplemental content in the content feed comprises:
determining boundaries of the supplemental content relative to a display screen;
identifying an amount of vertical screen space above and below the boundaries of the supplemental content; and
based at least in part on the amount of vertical screen space above and below the boundaries of the supplemental content being below a threshold, changing content of the supplemental content.

44. The system of claim 41, wherein:
the adjusting the supplemental content in the content feed comprises:
determining boundaries of the supplemental content relative to a display screen;
identifying an amount of horizontal screen space to a left side of and to a right side of the boundaries of the supplemental content; and
based at least in part on the amount of horizontal screen space to the left side of and to the right side of the boundaries of the supplemental content being below a threshold, changing content of the supplemental content.

45. The system of claim 41, wherein the scrolling characteristic comprises at least one of a scroll depth, a bounce rate, a load time, a size of a feed buffer, a size of the screen buffer, a size of an available memory, an eye gaze characteristic, a touchscreen input, a scroll pattern, a user interaction via a user device, a scroll position, a time on a page, or an end-of-scroll indicator.

46. The system of claim 41, wherein the content feed includes a video, and wherein the adjusting the supplemental content in the content feed comprises:
adjusting a video playout speed of the video based at least in part on a scrolling speed with respect to content in the content feed.

47. The system of claim 41, wherein the adjusting the supplemental content in the content feed comprises:
displaying a video embedded within the primary content being displayed;
detecting when the video embedded within the primary content being displayed is beyond at least a portion of the screen buffer allocated to the video; and
based at least in part on detecting the video embedded within the primary content being displayed is beyond the at least the portion of the screen buffer allocated to the video, displaying a modified video based on an unfinished portion of the video in a picture-in-picture window.

48. The system of claim 47, wherein the displaying the unfinished portion of the video in the picture-in-picture window is played with an accelerated adjusted speed.

49. The system of claim 48, wherein the displaying the unfinished portion of the video in the picture-in-picture window is played with the accelerated adjusted speed until a next content with video appears in the content feed.

50. The system of claim 41, wherein the adjusting the supplemental content in the content feed comprises:
dynamically adjusting rendering of images contained in the content feed.

51-177. (canceled)
